(19) United States
(12) Patent Application Publication
(10) Pub. No.: US 2024/0335972 A1
(43) Pub. Date: Oct. 10, 2024

(54) CHAINSAW AND DRIVE SYSTEM THEREFOR

(71) Applicant: Techtronic Cordless GP, Anderson, SC (US)

(72) Inventors: Christopher A. Holman, Clemson, SC (US); Lance Eckard, Anderson, SC (US); Ronald H. Hoffman, Cairo, GA (US); Brett Steenwyk, Greenville, SC (US)

(21) Appl. No.: 18/612,464

(22) Filed: Mar. 21, 2024

Related U.S. Application Data
(60) Provisional application No. 63/458,194, filed on Apr. 10, 2023.

(51) Int. Cl. B27B 17/02; B27B 17/08; B27B 17/12

(52) U.S. Cl. CPC B27B 17/02; B27B 17/08; B27B 17/12

(57) ABSTRACT

A chainsaw and a drive system therefor are provided. The drive system includes a motor operably coupled to drive a motor shaft and an output drive operably coupled to an output shaft. The motor shaft and the output shaft are mechanically coupled to one another by a transmission system to transfer energy from the motor to the output drive. The motor and motor shaft are coupled to a housing. The transmission system allows the output shaft to selectively change positions along a circumferential direction relative to a rotational axis of the motor shaft to selectively loosen or tighten a connection of the output drive to a chain at a guide bar.

### PRIORITY STATEMENT

The present application claims the benefit of priority to U.S. Provisional Patent Application Ser. No. 63/458,194, filed Apr. 10, 2023, the disclosure of which is incorporated herein in its entirety.

### FIELD

The present subject matter relates generally to chainsaws, lubrication systems for chainsaws, and chainsaw lubricants.

### BACKGROUND

Chainsaws typically include a guide bar that utilizes a chain provided therearound and which moves relative to the guide bar. Chains typically utilize a plurality of segments each having a cutting surface. As the chain is driven around the chain bar, the cutting surfaces of the chain segments cut into the surface being operated on.

Oil is typically utilized as the lubricant for chains in chainsaws. However, oil can be messy and can leak from the oil pump and/or chainsaw generally.

Chainsaws typically require mechanisms for tightening and loosening a chain. However, such mechanisms can be bulky and add weight to the chainsaw, which reduces usability of the chainsaw.

Accordingly, improved chainsaws, chainsaw lubricants, and lubrication systems for chainsaws are desired in the art. In particular, chainsaw lubricants and lubrication systems which are relatively less messy, improve durability, reduce wear, or improve chain performance would be desired.

### BRIEF DESCRIPTION

Aspects and advantages of the invention will be set forth in part in the following description, or may be obvious from the description, or may be learned through practice of the invention.

An aspect of the present disclosure is directed to a chainsaw including a drive system. The drive system includes a motor operably coupled to drive a motor shaft and an output drive operably coupled to an output shaft. The motor shaft and the output shaft are mechanically coupled to one another by a transmission system to transfer energy from the motor to the output drive. The motor and motor shaft are coupled to a housing. The transmission system allows the output shaft to selectively change positions along a circumferential direction relative to a rotational axis of the motor shaft to selectively loosen or tighten a connection of the output drive to a chain at a guide bar.

Another aspect of the present disclosure is directed to a drive system for a chainsaw. The drive system includes a motor shaft configured to rotate relative to a first rotational axis extending through the motor shaft. A motor is operably coupled to drive the motor shaft. The motor and the motor shaft are operably coupled to a housing. An output shaft is configured to rotate relative to a second rotational axis extending through the output shaft. The output shaft is separate from the motor shaft. An output drive is operably coupled to the output shaft. The motor shaft and the output shaft are operably coupled to one another by a transmission system to transfer energy from the motor to the output drive. The transmission system allows the second rotational axis at the output shaft to selectively change positions along a circumferential direction relative to the first rotational axis of the motor shaft.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an embodiment of a chainsaw in accordance with aspects of the present disclosure;

FIG. 2 provides a perspective view of an embodiment of a chainsaw in accordance with aspects of the present disclosure;

FIG. 3 provides a perspective view of an embodiment of a chainsaw in accordance with aspects of the present disclosure;

FIG. 4 provides a perspective view of an embodiment of a drive system for a chainsaw in accordance with aspects of the present disclosure;

FIG. 5 provides a side cutaway view of an embodiment of the drive system in accordance with aspects of the present disclosure;

FIG. 6 provides a perspective cutaway view of an embodiment of the drive system in accordance with aspects of the present disclosure;

FIG. 7A provides a partially transparent perspective view of an embodiment of the drive system in a first position in accordance with aspects of the present disclosure;

FIG. 7B provides a partially transparent perspective view of an embodiment of the drive system in a second position in accordance with aspects of the present disclosure;

FIG. 7C provides a detailed view of an exemplary embodiment of a tensioner mechanism in accordance with aspects of the present disclosure;

FIG. 8A provides a perspective view of an embodiment of the drive system of FIGS. 7A-7B in accordance with aspects of the present disclosure;

FIG. 8B provides a perspective view of an embodiment of the drive system of FIGS. 7A-7B in accordance with aspects of the present disclosure;

FIG. 8C provides a partially transparent perspective view of an embodiment of the drive system of FIGS. 7A-7B in accordance with aspects of the present disclosure;

FIG. 9A provides an exploded view of a user interface of a tensioner mechanism in accordance with aspects of the present disclosure;

FIG. 9B provides an exploded view of the user interface of a tensioner mechanism in accordance with aspects of the present disclosure;

FIG. 10 provides a partially transparent perspective view of an embodiment of the drive system in accordance with aspects of the present disclosure;

FIG. 11 provides a partially transparent perspective view of a pump assembly for the drive system in accordance with aspects of the present disclosure;

FIG. 12 provides a partially transparent perspective view of the drive system in accordance with aspects of the present disclosure;

FIG. 13 provides a perspective view of an embodiment of a pump assembly for a chainsaw in accordance with aspects of the present disclosure;

FIG. 14 provides a perspective view of a portion of the pump assembly in accordance with aspects of the present disclosure;

FIG. 15 provides a perspective view of a portion of an embodiment a chainsaw in accordance with aspects of the present disclosure;

FIG. 16A provides an embodiment of a reservoir for the chainsaw lubricant in accordance with aspects of the present disclosure;

FIG. 16B provides an embodiment of the reservoir for the chainsaw lubricant in accordance with aspects of the present disclosure;

FIG. 17 provides a side view of an embodiment of a reservoir for the chainsaw lubricant in accordance with aspects of the present disclosure;

FIG. 18 provides a perspective view of an embodiment of a reservoir for the chainsaw lubricant and positioning interface in accordance with aspects of the present disclosure;

FIG. 19a provides a side view of an embodiment of a reservoir for a lubrication system in a first position in accordance with aspects of the present disclosure;

FIG. 19b provides a side view of an embodiment of a reservoir for the lubrication system in a second position in accordance with aspects of the present disclosure;

FIG. 20 provides a side cross-sectional view of an embodiment of a lubrication system in accordance with aspects of the present disclosure;

FIG. 21 provides a perspective view of an embodiment of a reservoir for the chainsaw lubricant in accordance with aspects of the present disclosure;

FIG. 22 provides a perspective view of an embodiment of the pump assembly in accordance with aspects of the present disclosure;

FIG. 23 provides a side cross-sectional view of an embodiment of the pump assembly in accordance with aspects of the present disclosure;

FIG. 24 provides a side view of an embodiment of a chainsaw in a first position in accordance with aspects of the present disclosure;

FIG. 25 provides a side view of an embodiment of a chainsaw in a second position in accordance with aspects of the present disclosure;

FIG. 26 provides a side view of an embodiment of a chainsaw in a third position in accordance with aspects of the present disclosure;

FIG. 27 provides a perspective view of an embodiment of the chainsaw in accordance with aspects of the present disclosure; and

FIG. 28 provides a rear view of an embodiment of the chainsaw in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The present disclosure is generally directed to improved chainsaws, chainsaw lubricants, lubrication systems, drive systems, tensioner mechanisms, braking mechanisms, and pump assemblies, such addressing one or more of the above-identified issues with some known chainsaws.

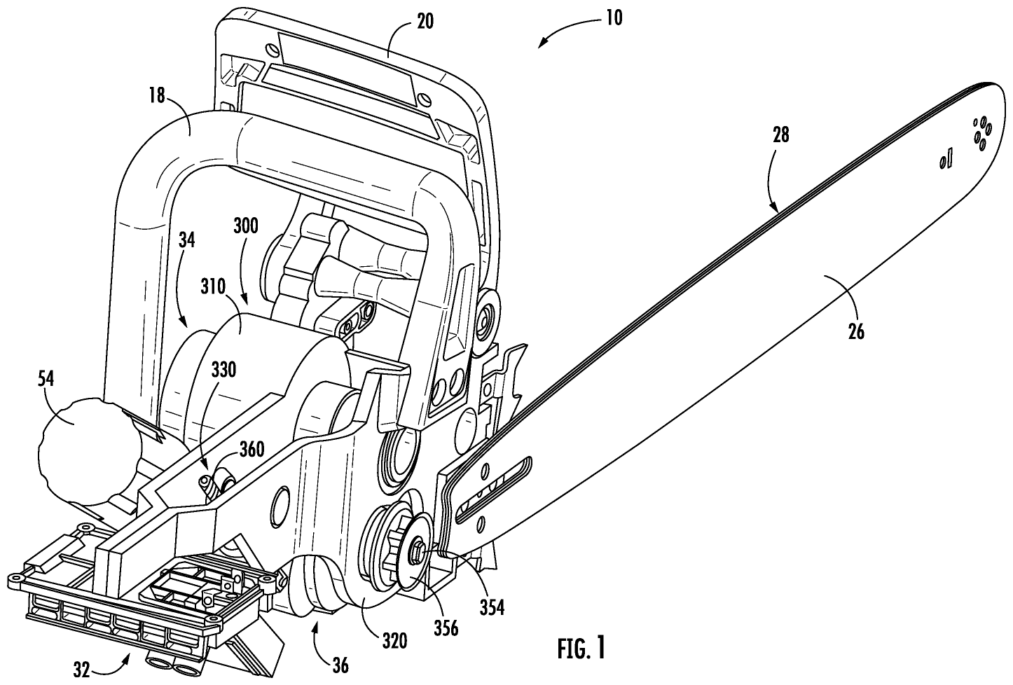

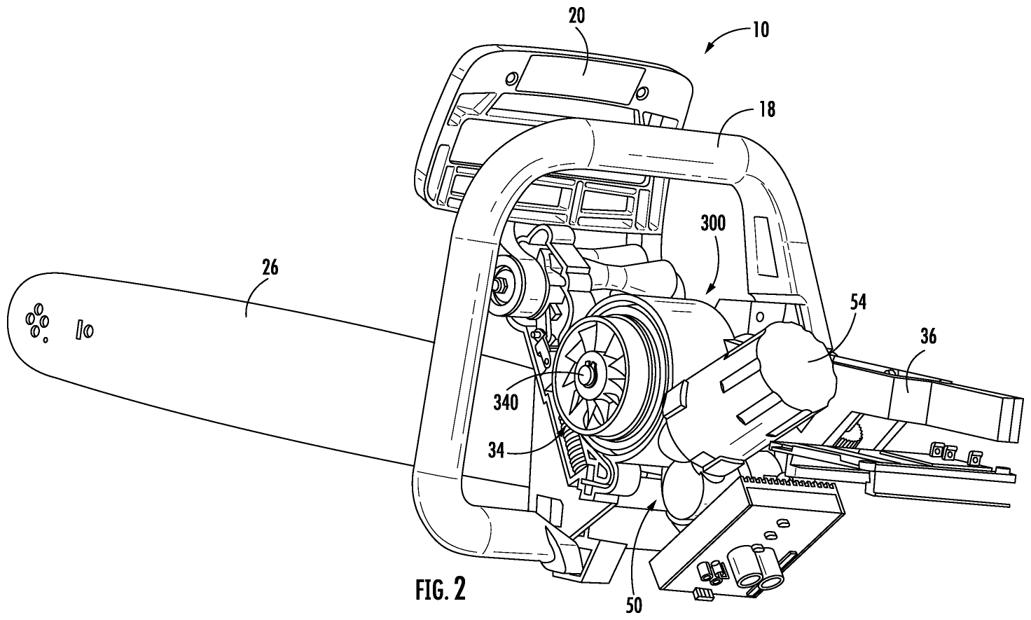

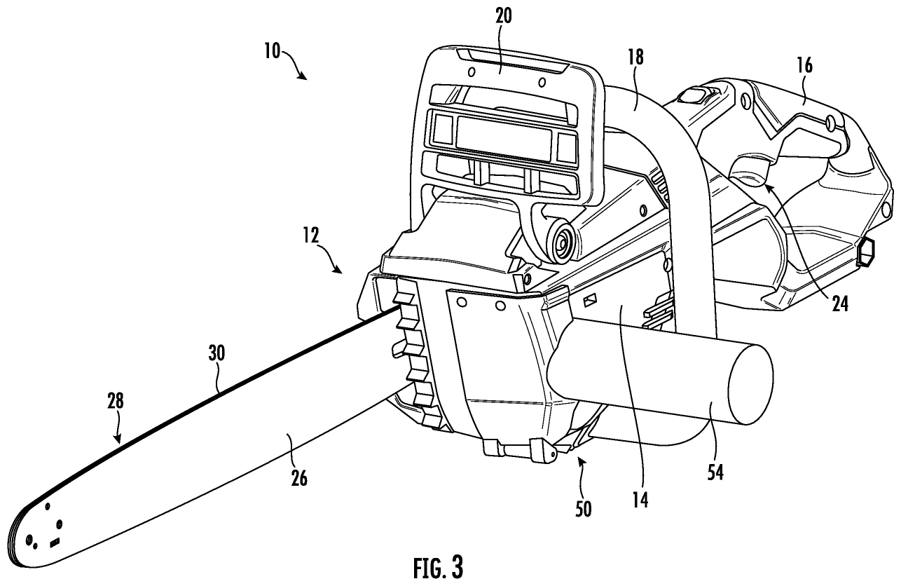

Referring to the FIGS. 1-9, embodiments of a chainsaw 10 in accordance with aspects of the present disclosure are provided. Referring to FIGS. 1-3, the chainsaw 10 may generally include a frame 36 configured at which various components of the chainsaw 10 may be attached, such as described in various embodiments herein. The chainsaw 10 includes a guide bar 26 that may include a track 28 extending around a perimeter of the guide bar 26. A chain 30 can be guided along the track 28 so as to travel around the guide bar 26. The chain can include a plurality of connective segments each having at least one cutting surface. Referring briefly to FIG. 3, in various embodiments, the chainsaw 10 may include having a housing 14 and one or more handles, such as a rear handle 16 and a front handle 18. In certain embodiments, a guard 20 extends from the housing 14, such as between a guide bar 26 with chain 30 and one or more handles 16, 18. Guard 20 may generally be configured to provide a wall or barrier, such as a protective barrier, between a user (including, e.g., a user's hand) and a cutting tool, such as chain 30. Chainsaw 10 may include a braking mechanism 22, a trigger 24, and a guide bar 26. The guide bar 26 can extend from the housing 14 and project a distance therefrom.

In various embodiments, such as further described herein, the chainsaw 10 includes a tensioner mechanism 330 configured to adjust tension of the chain 30 at the guide bar 26. In accordance with one or more embodiments of the present disclosure, the tensioner mechanism 330 allows the operator to take up the slack in the chain 30. In some embodiments, the guide bar 26 is fixed relative to the frame 36, and the tensioner mechanism 330 may be configured to remove slack in the chain 30 while affixing a position of the guide bar 26 relative to the frame 36.

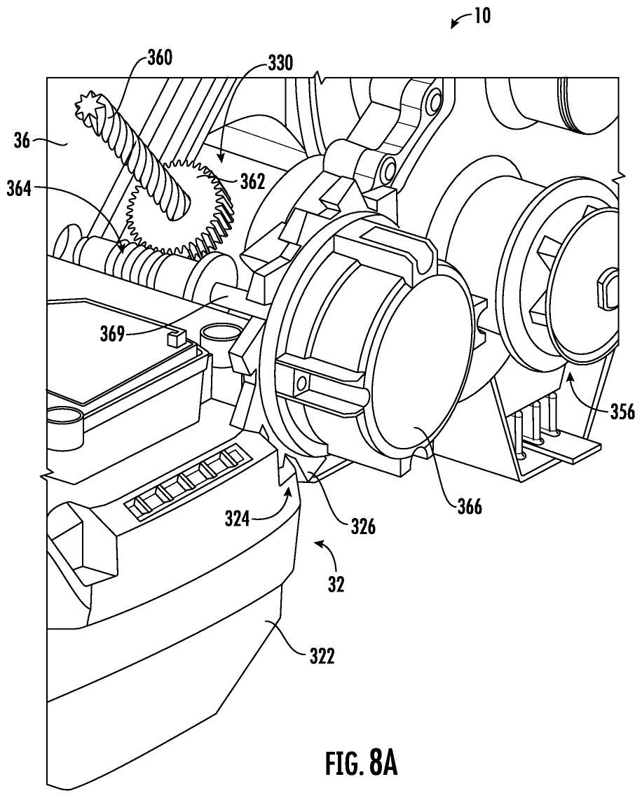

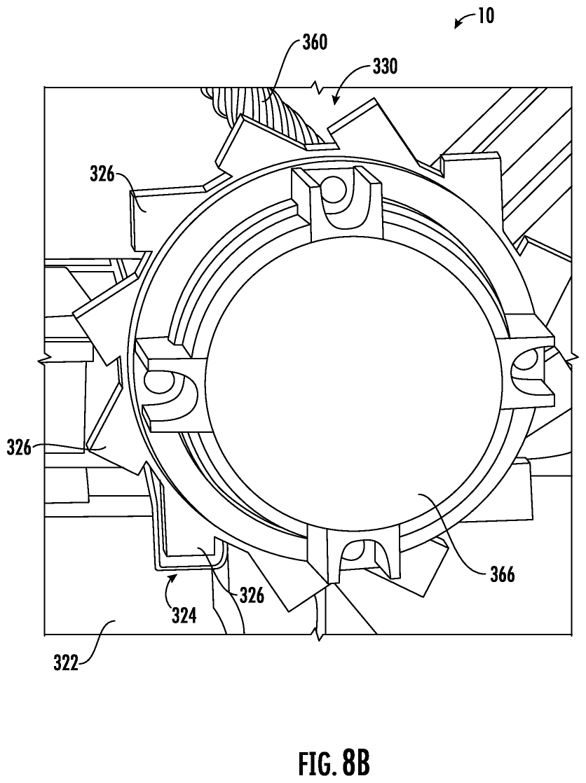

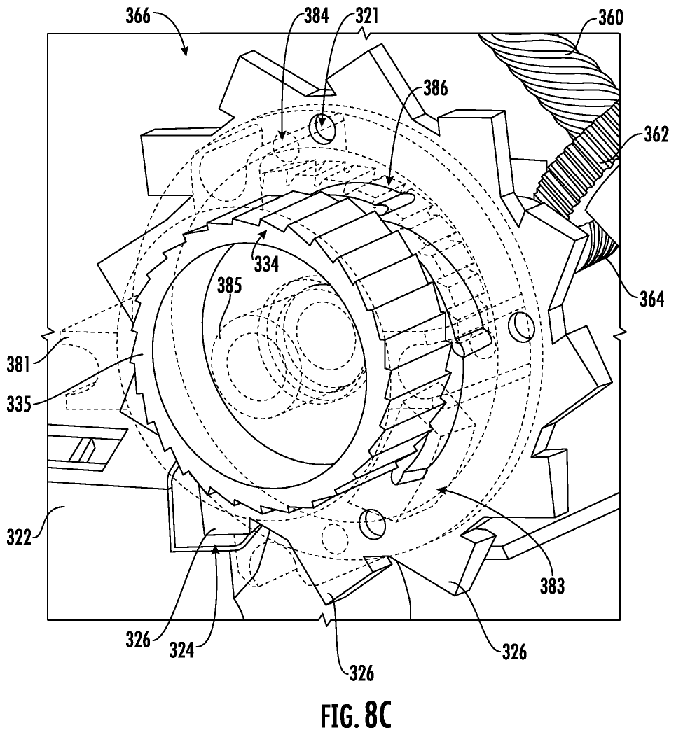

Embodiments of the chainsaw 10 provided herein may include a power unit 32 operably coupled to a motor 34 to provide power to drive the chainsaw 10. The power unit 32 can include an electrical power unit or a gas power unit. For instance, FIGS. 8A-8C depict the power unit 32 including an electrical power unit 322 forming a battery or capacitor configured to provide energy to operate the chainsaw 30. The present subject matter described herein is not limited to any particular style, model, or configuration of power unit 32.

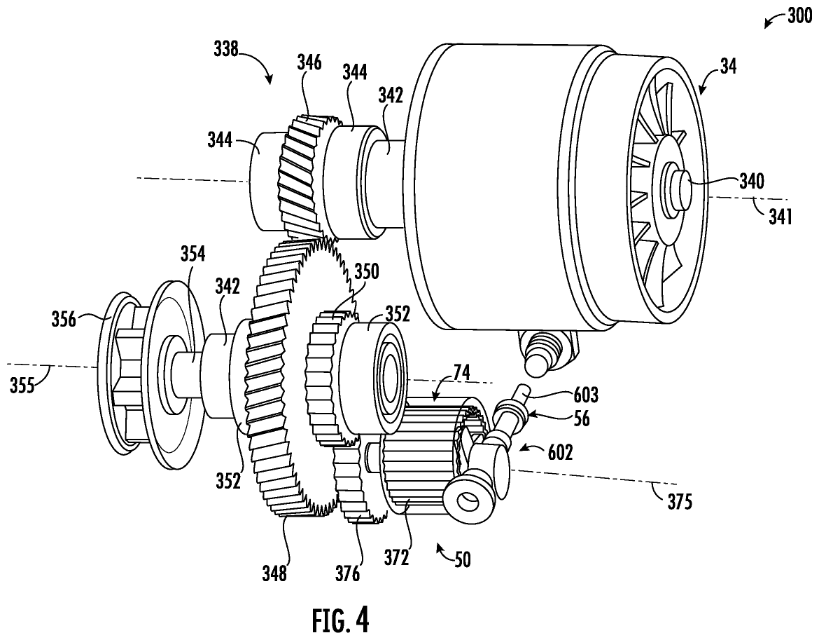

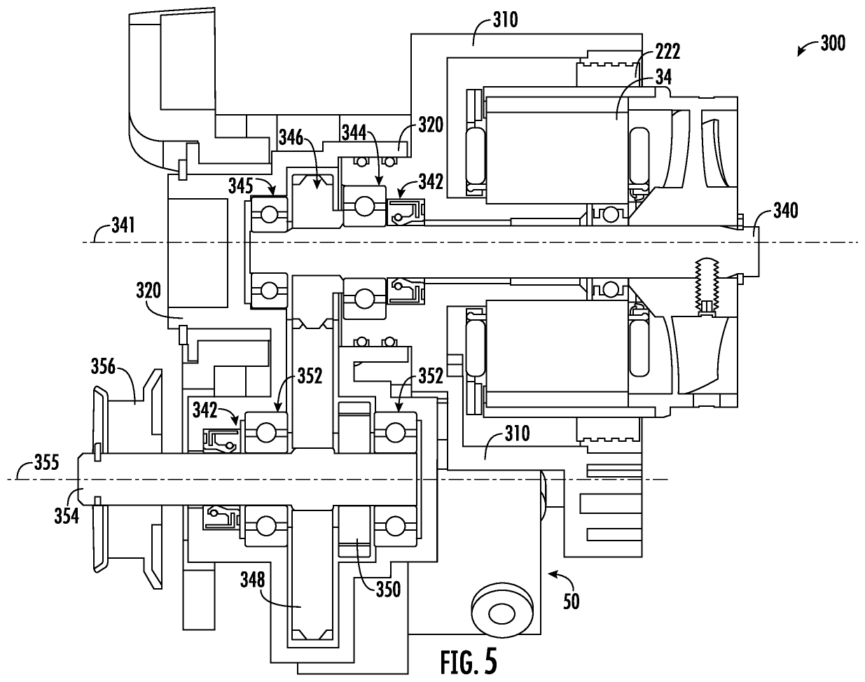

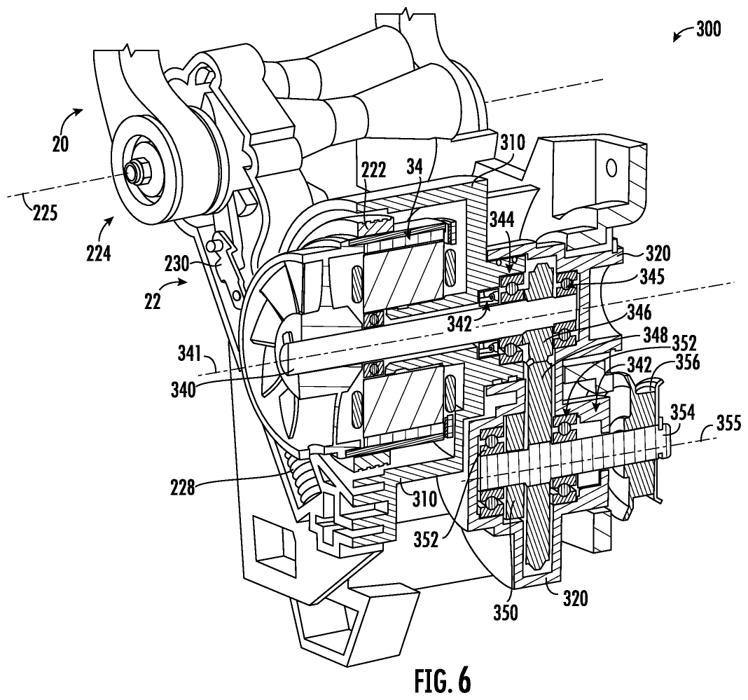

FIG. 4 provides a perspective view of a drive system 300 for a chainsaw (e.g., chainsaw 10). FIG. 5 provides a cross-sectional view of an embodiment of the drive system 300. FIG. 6 provides a perspective cutaway view of an embodiment of the drive system 300. Referring to FIGS. 4-6, embodiments of the drive system 300 include a motor 34 having motor shaft 340 operably coupled for rotation by the motor 34 relative to a first rotational axis 341. The drive system 300 includes an output shaft 354 operably coupled to an output drive 356 for rotation relative to a second rotational axis 355. The output drive 356 is configured to transfer power to operate the chain 30 at the chainsaw 10 (FIGS. 1-3). In various embodiments, the output drive 356 may include a sprocket, a chainwheel, a gear, a toothed wheel, or other appropriate device for transferring motive force to operate the chain 30 at the chainsaw 10.

In various embodiments, the motor shaft 340 and the output shaft 354 form separate shafts. For instance, the motor shaft 340 and the output shaft 354 may be positioned at separate planes and extending parallel to one another. Power may transfer from the motor 34 to the output drive 256 through a transmission system 338. Separate shafts 340, 354 may facilitate tensioning of a chain at the chainsaw (e.g., chain 30 at chainsaw 10), such as by allowing the motor 34 to remain affixed or stationary (e.g., without moving a rotational axis of the motor 34).

Embodiments of the transmission system 338 include a plurality of gears 346, 348 operably connecting the motor shaft 340 to the output shaft 354. The plurality of gears 346, 348 may form a compound gear assembly including a first gear 346 coupled to the motor shaft 340 and a second gear 348 coupled to the output shaft 354. The transmission system 338 is configured to transmit energy from the motor shaft 340 and the first gear 346 to the output shaft 354 through the second gear 348.

In some embodiments, such as depicted in FIGS. 4-6, the gears 346, 348 may be directed coupled or meshed to one another, such as to transfer torque or power from the motor shaft 340 to the output shaft 354. The plurality of gears 346, 348 may form a reduction gear assembly, such as to allow a speed (e.g., a first speed) of the motor shaft 340 to be different from a speed of the output shaft 354 (e.g., a second speed).

In various embodiments, the plurality of gears 346, 348 forming a reduction gear assembly may be configured with between a 1.5:1 gear reduction to a 3:1 gear reduction, or between a 2:1 to 2:75 gear reduction, or between a 2:10 to 2.30 gear reduction, or between a 2:10 to 2:20 gear reduction.

It should be appreciated that in other embodiments the plurality of gears may include one or more gears positioned between the first gear 346, 348, such that the gears 346, 348 are indirectly coupled to one another.

The drive system 300 includes a motor housing 310 at which the motor 34 is affixed. In various embodiments, the drive system 300 includes a motor shaft bearing 344 coupled to the motor shaft 340 to support rotation of the motor shaft 340. In an embodiment, one or more bearings 344 is coupled to the housing 310 to support rotation of the motor shaft 340.

The drive system 300 includes an output housing 320 at which the output shaft 354 is positioned. In various embodiments, the drive system 300 includes an output shaft bearing 352 coupled to the output shaft 354 to support rotation of the output shaft 354. In an embodiment, one or more bearings 352 is coupled to the housing 320 to support rotation of the output shaft 354.

In some embodiments, a second motor shaft bearing 345 is coupled to the motor shaft 340 and the output housing 320. For instance, a portion of the motor shaft 340 may extend into the motor housing 310 and into the output housing 320, such as to allow the motor shaft 340 to be rotatably supported by the housings 310, 320 by bearings 344, 345 at the respective housings 310, 320. In various embodiments, the motor housing 310 affixes the first rotational axis 341 of the motor 34 and motor shaft 340. The transmission system 338 may allow the output shaft 354 and output drive 356 to change circumferential positions of the second rotational axis 355 relative to the first rotational axis 341.

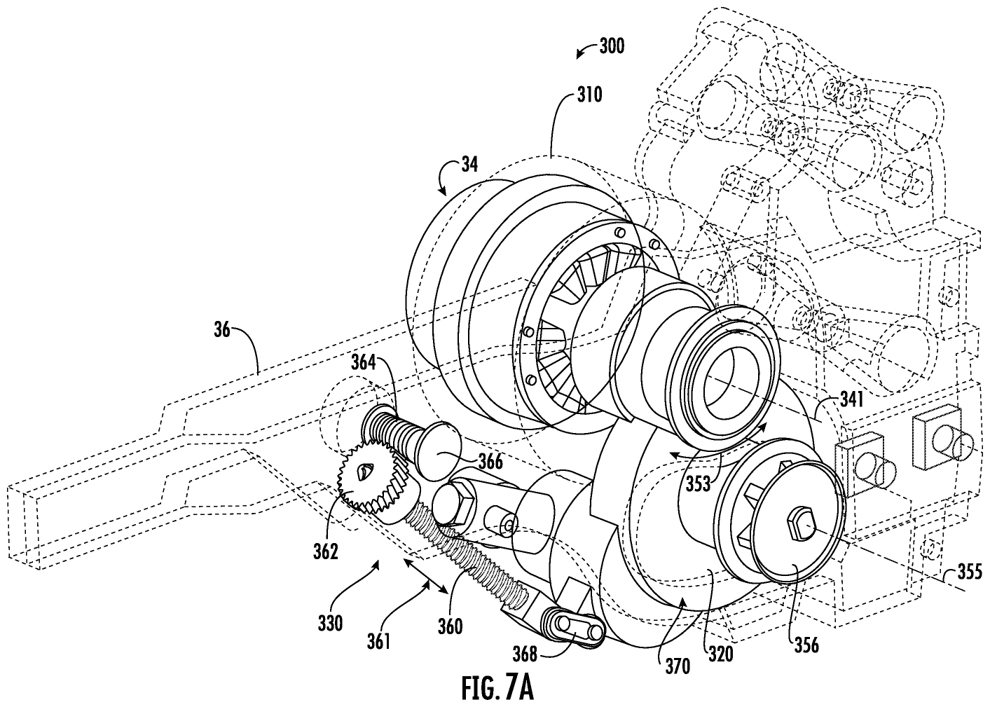

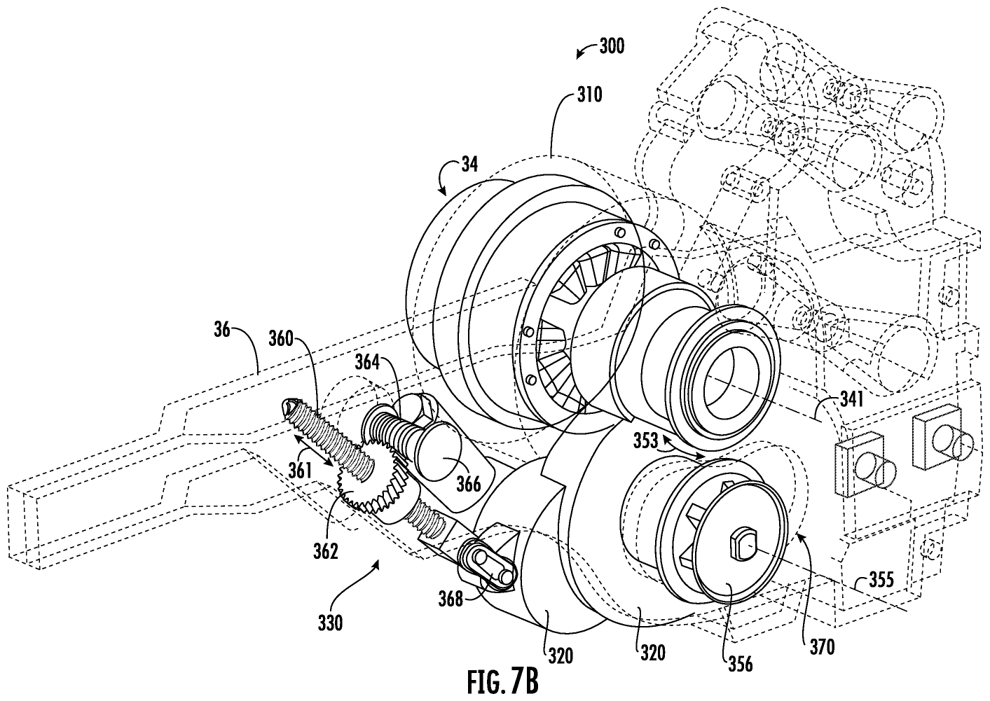

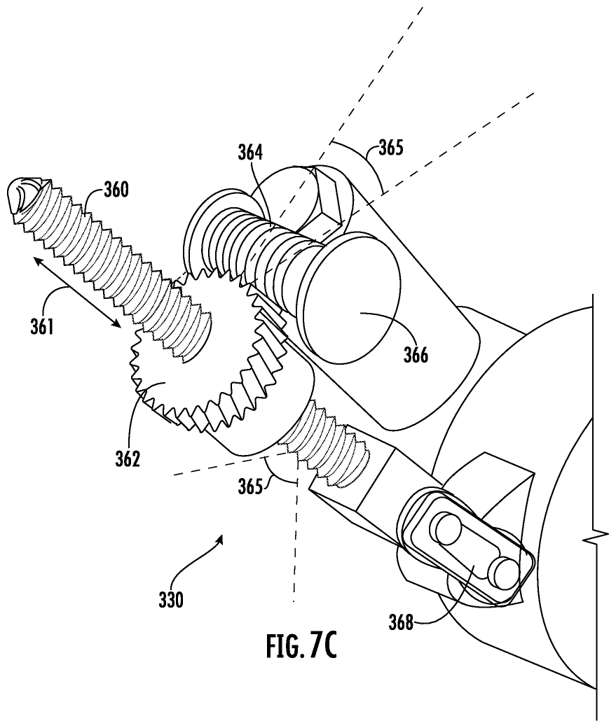

For instance, the plurality of gears 346, 348 may allow for the output shaft 354 to rotate along a circumferential direction 353 (FIGS. 7A-7B) relative to the first rotational axis 341. The first gear 346 is coupled to the motor shaft 340 such that the first gear 346 and motor shaft 340 rotate along the same first rotational axis 341. The second gear 348 coupled to the output shaft 354 together rotate along the same second rotational axis 355. The first and second gears 346, 348 are meshed together. Additionally, the second gear 248, and the output shaft 254 coupled thereto, are selectively allowed to change circumferential position relative to the first rotational axis 341.

The drive system 300 may include one or more seals 342 positioned at shafts 340, 354 and configured to mitigate fluid communication across the bearing 344, 345, 352. In various embodiments, the seal 342 is positioned between a distal end of the respective shaft 340, 354 and the gears 346, 348 attached to the respective shafts 340, 354. For instance, the distal end may be defined at which the motor 34 or output drive 356 is positioned on the respective shaft 340, 354. The seal 342 may be positioned at the motor shaft 340 between the motor 34 and the first gear 346. The seal 342 may be positioned at the output shaft 354 between the output drive 356 and the second gear 346. It should be appreciated that the seal 342, or additional seals, may be positioned at various locations such as to limit fluid leakage (e.g., lubricant leakage) from the transmission system 338. Various embodiments of seal 342 may include any appropriate type of seal between a rotating element (e.g., shafts 340, 354) and a static element (e.g., housing 310, 320). For example, seal 342 may include a labyrinth seal, a lip seal, shaft seal, or other appropriate type of seal.

Still various embodiments of the drive system 300 may include a seal 343 between the motor housing 310 and the output housing 320. Various embodiments of seal 343 may include any appropriate type of seal between substantially static elements (e.g., housing 310, 320). For example, seal 343 may include an O-ring, rope seal, a sealant material, a pressure differential, or other appropriate type of seal.

Referring to FIGS. 7A-7B, perspective views of an embodiment of a portion of the chainsaw 10 including an embodiment of the drive system 300 are provided. In various embodiments, the chainsaw 10 includes a tensioner mechanism 330 configured to selectively tighten or loosen a chain at a chainsaw (e.g., chain 30 at chainsaw 10). The tensioner mechanism 330 forms a drive assembly including a plurality of drive accessories 360, 362, 364 operably coupling a user interface 366 to the output housing 320 to actuate the output housing 320 along the circumferential direction 353. A first drive accessory 360 may form a lead screw coupled to a second drive accessory 362 forming a worm gear. The second drive accessory 362 forming a worm gear is coupled to the first drive accessory 360 forming the lead screw such that rotation of the worm gear drives the lead screw up or down, such as depicted schematically via arrows 361. The second drive accessory 362 forming the worm gear is operably coupled to a third drive accessory 364 forming a worm shaft, such as in a gear mesh arrangement. The third drive accessory 364 forming the worm shaft includes or is attached to the user interface 366, such that when a user rotates the user interface 366, the third drive accessory 364 rotates. For instance, a shaft 369 may extend to transfer torque or rotation of the user interface 366 to the third drive accessory 364. Rotation of the third drive accessory 364 rotates the second drive accessory 362, such that the second drive accessory 362 rotates around the first drive accessory 360 to translate the first drive accessory 360 along direction 361. The first drive accessory 360 is coupled to the output housing 320 such that translation of the first drive accessory 360 causes rotation of the output housing 320.

The user interface 366, the third drive accessory 364, or both, may extend into the frame 36, such as to mount the user interface 366 and the third drive accessory 364. In some embodiments, a linkage 368 couples the first drive accessory 360 to the output housing 320, such as to facilitate transfer of linear movement of the first drive accessory 360 (e.g., along direction 361) to rotational movement of the output housing 320 (e.g., along circumferential direction 353).

In still some embodiments, the frame 36 forms a track 370 extending at least partially along the circumferential direction 353. The track 370 may support or guide movement of the output drive 356 along the circumferential direction 353. Referring to FIG. 7A, an exemplary embodiment of the drive system 300 including the tensioner mechanism 330 in an extended position is provided. Referring to FIG. 7B, an exemplary embodiment of the drive system 300 including the tensioner mechanism 330 in a retracted position is provided. Referring to FIGS. 7A-7B, in various embodiments, the drive system 300 is configured to allow for rotation along the circumferential direction 353 of up to 45 degrees. However, it should be appreciated that other embodiments may be configured to allow for greater rotation, such as including a larger lead screw, track, housing, linkage, or other components. In still various embodiments, the drive accessories 360, 362, 364 or track 370 may be configured to limit translation or rotation of the output shaft 354, such as to prevent over-tensioning of the chain attached to the output drive.

The tensioner mechanism 330 may be configured as a self-locking system preventing un-commanded back-driving of the gears. The plurality of drive accessories may include a lead angle that is self-locking. In various embodiments, the lead angle at the drive accessories is self-locking when the lead angle is larger than a static friction angle at the drive accessories. As power transmission between two or more of the drive accessories may be performed substantially or entirely through sliding motion between two or more of the drive accessories, the static friction angle is the arctan of a static coefficient of friction at the drive accessories.

Referring to FIG. 7C, a detailed view of an exemplary embodiment of the tensioner mechanism 330 is provided. As described herein, the plurality of drive accessories 360, 362, 364 may include a lead screw, a worm gear, and a worm shaft in a gear mesh arrangement. For instance, in various embodiments, third drive accessory 364 is in a gear mesh arrangement with second drive accessory 362, and second drive accessory 362 is in a gear mesh arrangement with first drive accessory 360. Third drive accessory 364 is configured to receive power (e.g., from user manipulation at user interface 366). Power is transmitted through the third drive accessory 364, the second drive accessory 362, and the first drive accessory 360. Weight of the output housing 320, or components attached to the output housing 320, may generate static loads that provide forces acting at the drive accessories 360, 362, 364. Dynamic loads from driving the drive system 300, or components attached to the drive system 300, may add tension to the chain and generate forces acting at the drive accessories 360, 362, 364. Forces generated from dynamic loads may be substantially greater than forces generated from static loads. A lead angle 365 at the gears coupling the third drive accessory 364 and second drive accessory 362, the second drive accessory 362 to the first drive accessory 360, or both, is larger than a static friction angle at the drive accessories. For instance, the static coefficient of friction corresponding to the static friction angle may correspond, at least in part, to the static forces, dynamic forces, or both. One or more of the lead angles may be greater than the static friction angle, such as may configure the tensioner mechanism 330 as self-locking.

Referring to FIGS. 8A-8C, perspective views of an embodiment of a portion of the chainsaw 10 including an embodiment of the tensioner mechanism 330 are provided. The embodiment depicted in FIGS. 8A-8C is configured substantially as described in regard to FIGS. 7A-7B. In FIGS. 8A-8C, the user interface 366 includes a key 326 configured to abut a notch or surface 324 at a removable electrical power unit 322 (e.g., a battery, capacitor, etc.). The surface 324 may form a step, notch, or other feature corresponding to the key 326 or otherwise allowing the key 326 to abut the surface 324 to prevent rotation of the user interface 366. The user interface 366 may form the key 326 as a plurality of teeth distributed around the user interface 366. The key 326 positioned at, proximate to, or abutting the surface 324 may prevent rotation of the user interface 366. The key 326 and surface 324 may prevent operation of the tensioner mechanism 330 while the motor 34 is energized, such as to prevent operation of the chain 30 while adjusting tension of the chain 30. In an exemplary method for operation, a user may remove the electrical power unit 322 (e.g., remove the electrical power unit 322 from attachment to the frame 36) to allow the user interface 366 to rotate and adjust tension of the chain 30 or positioning of the lubrication system 50, such as described in regard to FIGS. 7A-7B.

In various embodiments, the user interface 366 abutting the surface 324 may dampen vibrational effects from the plurality of drive accessories 360, 362, 364. Accordingly, the key 326 and surface 324 may form a dampener device. In still various embodiments, physical properties at the electrical power unit 322 may be altered to promote desired dampening. For instance, material, weight, density, or other properties of the electrical power unit 322 may be tuned to limit vibrational or resonance affects from the tensioner mechanism 330, the drive system 300, the chain 30, the motor 34, the lubrication system 50, the braking mechanism 22, or combinations thereof, or the chainsaw 30 generally.

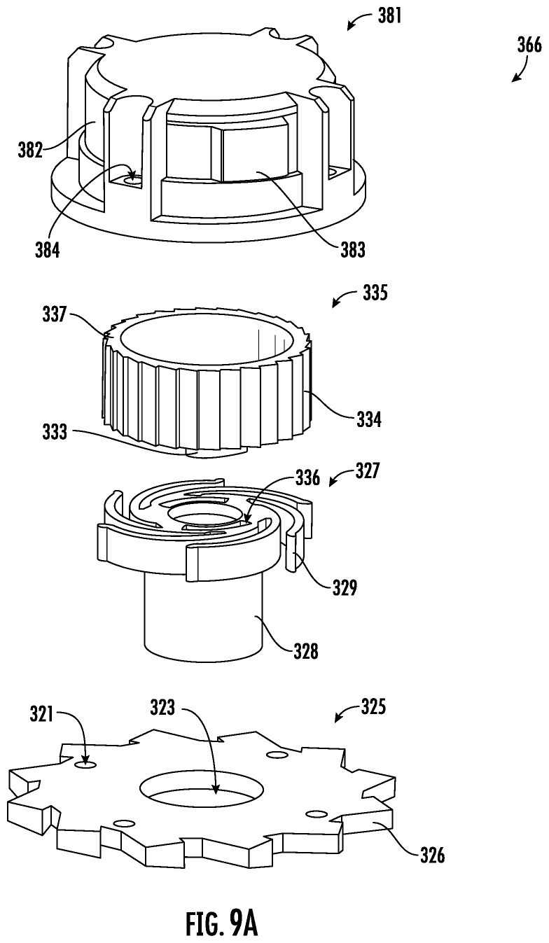

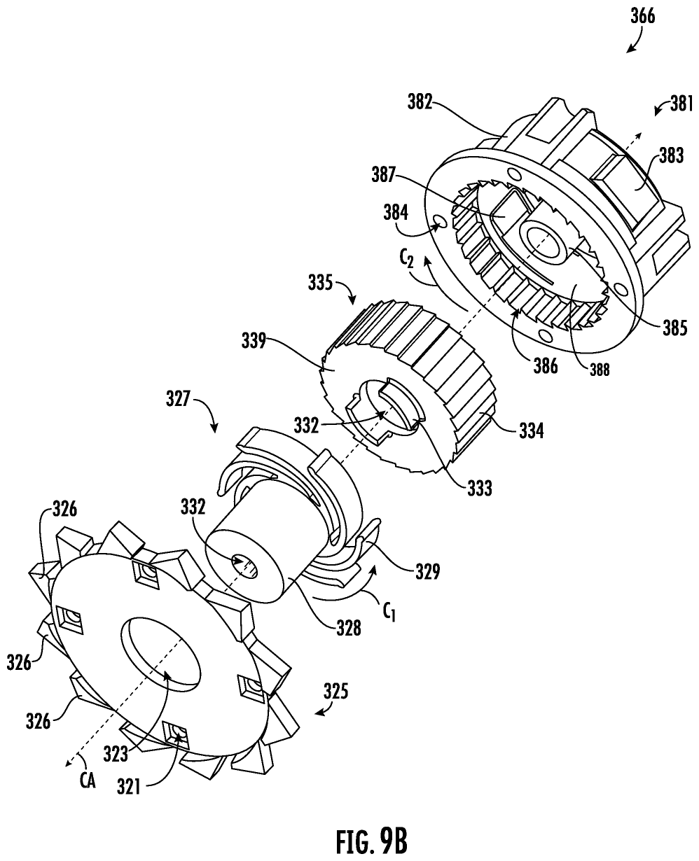

Referring now to FIGS. 9A-9B, exploded perspective views of an embodiment of the user interface 366 forming a ratcheting knob assembly are provided. Embodiments of the user interface 366 depicted and described in regard to FIGS. 8A-8C may be formed as the ratcheting knob assembly. Embodiments of the user interface 366 include a knob body 381 forming an interface at which a user grabs and articulates to operate the tensioner mechanism 330 such as described in regard to FIGS. 7A-7B. The knob body 381 may form a substantially cylindrical body having an exterior wall 382. A button 383 extends from exterior outer wall 382 and can be depressed by a user to lock a ratchet mechanism 327, such as to override a preset tension.

The user interface 366 includes a ratchet lock wheel 335 having a body 337 configured to extend into the knob body 381. The lock wheel body 337 includes a plurality of teeth 334 extending outward from the body 337 The lock button 383 at the knob body 381 engages with teeth 334 at the lock wheel 335 to lock the knob body 381 and the ratchet lock wheel 335 together, such as to bypass the ratcheting mechanism for preset tension. For instance, the knob body 381 may include a knob spring arm 387 extending from an interior wall 388 of the knob body 381. The knob spring arm 387 may extend at least partially along a circumferential direction from the interior wall 388. The button 383 is configured to depress the knob spring arm 387 radially inward to engage teeth 334 at the lock wheel 335 when the lock wheel 335 is positioned into the knob body 381.

The user interface 366 includes a ratchet mechanism 327 including a centerbody 328 and a ratchet spring arm 329 extending from the centerbody 328. A plurality of ratchet spring arms 329 may extend from the centerbody 328 in substantially circumferentially adjacent arrangement around the centerbody 328. The ratchet spring arm 329 may extend at least partially in a first circumferential direction C1 (relative to center axis CA) opposite of the knob spring arm 387 extending at least partially in a second circumferential direction C2. The ratchet spring arm 329 is configured to allow ratchet mechanism 327 to slip once a threshold resistance is exceeded. For instance, the threshold resistance may correspond to a desired tension at the chain 30 (FIG. 3).

In various embodiments, the user interface 366 includes an anti-rotation body 325 including the key 326, such as described above. The body 325 may form a disc including a plurality of keys 326 in adjacent circumferential arrangement. The body 325 may include a fastener opening 321 corresponding to a fastener opening 384 at the knob body 381. The user interface 366 may include the knob body 381, the lock wheel 335, the ratchet mechanism 327, and the anti-rotation body 325 in serial adjacent arrangement along the center axis CA such that a fastener extending through respective fastener openings 384, 321 at the knob body 381 and anti-rotation body 325 position and secure the ratchet mechanism 327 and lock wheel 335 at least partially within an interior volume of the knob body 381.

The ratchet spring arm 329 is configured to abut or interface at a plurality of knob body teeth 386 extending from the interior wall 388 of the knob body 381. The plurality of teeth 386 may extend radially inward (i.e., toward the center axis CA), such as to provide a surface at which the spring arm 329 may react against. The teeth 386 reacting against the spring arm 329 may prevent rotation of the knob body 381 in the first circumferential direction C1. The spring arm 329 is contoured such as to allow rotation along the second circumferential direction C2 (i.e., opposite of the first circumferential direction C1). For instance, the contour of the spring arm 329, a contour or angle of the teeth 386, or both, may allow the spring arm 329 to slip across the teeth 386 when rotated along the second circumferential direction C2.

In various embodiments, the lock wheel 335 includes a post 333 extending from the body 337. For instance, the post 333 may extend from a bottom wall 339 of the body 337. The post 333 may generally include a member, rod, or wall configured to extend into an opening 336 at ratchet mechanism 327. The opening 336 is formed at a top face of the ratchet mechanism 327, such as a top face of the centerbody 328. The post 333 extended into the opening 336 couples the lock wheel 335 to the ratchet mechanism 327, such that rotation or torque applied to the lock wheel 335 transfers to the ratchet mechanism 327.

In still various embodiments, knob body 381 may include a knob centerbody 385 extending along the center axis CA, such as to provide a mount surface at which the lock wheel 335 may be positioned within the knob body 381. The plurality of teeth 334 at the lock wheel 335 is positioned co-axially along the center axis CA to the knob spring arm 387 within the knob body 381. The plurality of ratchet spring arms 329 is positioned co-axially along the center axis CA to the plurality of teeth 386 at the knob body 381.

The lock wheel 335 may freely rest upon the centerbody 385, such that rotation of the knob body 381 does not translate torque or rotation to the lock wheel 335 until the button 383 is depressed by a user to selectively engage the knob spring arm 387 to the plurality of teeth 334 at the lock wheel 335. Rotation and torque transfers to operate the plurality of drive accessories 360, 362, 364 such as described in regard to FIGS. 7A-7B when the knob body 381 is engaged to the lock wheel 335 and further engaged to the ratchet mechanism 327 through post 333 and opening 326. For instance, ratchet centerbody 328 extends through an opening 323 through anti-rotation body 325. The third drive accessory 364 includes a shaft 369 extending through a passage 332 formed at the centerbody 328, such as to connect the user interface 366 to the third accessory 364 and translate motion therethrough such as described in regard to FIGS. 7A-7B. For instance, the shaft 369 may be formed integrally to the centerbody 328, or may be fitted into the passage 332 (e.g., tight fit, interference fit, press fit, etc.), or retained via a fastener.

When the ratchet mechanism 327 is rotated along an opposite direction (i.e., rotated against tightening), the ratchet mechanism 327 engages teeth 386 at the knob body 381. For instance, when the chain 30 or tensioner mechanism 330 is overtightened (e.g., in excess of the threshold resistance), the spring arm 329 slips and engages another tooth 386, such as to prevent over-tensioning. Anti-rotation body 325 may inhibit rotation of the user interface 366 when the electrical power unit 322 is attached to the chainsaw 10, such as described above.

Embodiments of the user interface 366 forming the knob assembly may allow for tightening the chain 30 to a predetermine tension using the ratchet mechanism 327. The key 326 positioned at the surface 324 at the electrical power unit 322 prevents adjustment of tension while the chain receives power, or while the chainsaw is or may be in an energized state, such as may mitigate damage to the chainsaw 10, or to further provide safe usage of the chainsaw 10. The ratchet mechanism 327 may lock or inhibit movement of the tensioner mechanism 330, such as the plurality of drive accessories 360, 362, 364, such as to inhibit undesired changes in tension. Selective engagement of the knob spring arm 387 to the lock wheel 335 may allow a user to selectively override the preset tension, such as to increase or decrease tension.

Referring now to FIG. 6 and FIG. 10, perspective views of the drive system 300 including an embodiment of a braking mechanism 22 are provided. The braking mechanism 22 includes a collar 222 extending around the motor 34. The collar 222 is actuatable to selectively clamp or otherwise attach onto the motor 34 to cease operation of the motor 34. A linkage assembly 220 operably couples the guard 20 to the collar 222. A pivot mechanism 224 is attached to the guard 20 to allow rotation of the guard 20 relative to a rotational axis 225. For instance, a user may apply a force to the guard 20 to induce rotation at the pivot mechanism 224. The rotational axis 225 may be substantially parallel to the first and second axes 341, 355. The linkage assembly 220 may include a chain or belt 228 coupled to the pivot mechanism 224. Rotation of the pivot mechanism 224 may pull the belt 228 and cause the collar 222 to contract or otherwise displace onto the motor 34 to cease rotation and cause the motor shaft 340, gears 346, 348, and output shaft 354 to cease rotation. In various embodiments, a linkage 230 may couple the pivot mechanism 224 to the belt 228, such as to translate rotational movement along the rotational axis 225 to linear movement of the belt 228.

In some embodiments, the collar 222 includes a first material and the motor 34 includes a second material. For instance, in various embodiments, the collar 222 includes a steel or steel alloy material and the motor 34 includes an aluminum or aluminum alloy material. The dissimilar materials may facilitate stopping operation of the motor 34 while mitigating bonding or failure of the materials under high temperature or high stress operation.

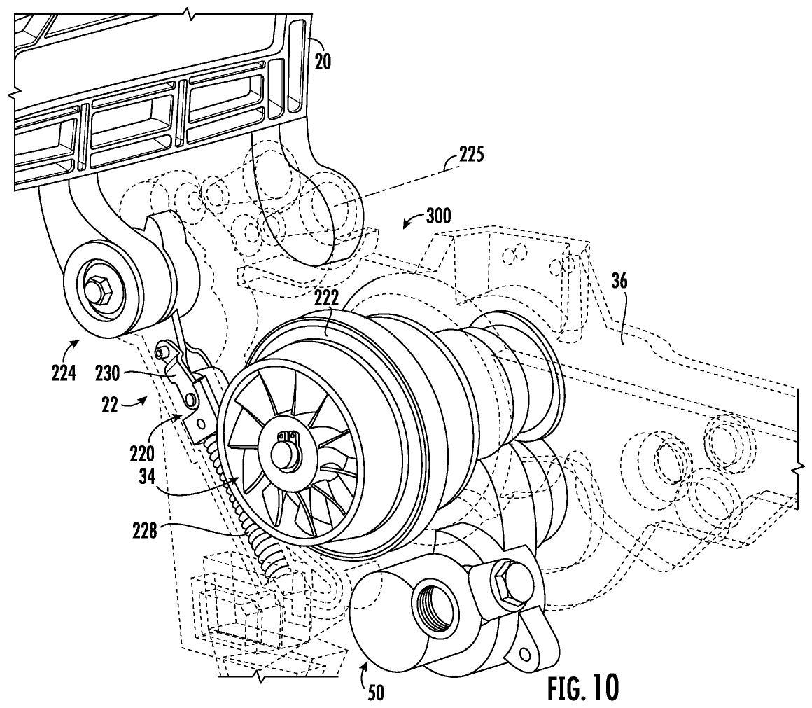

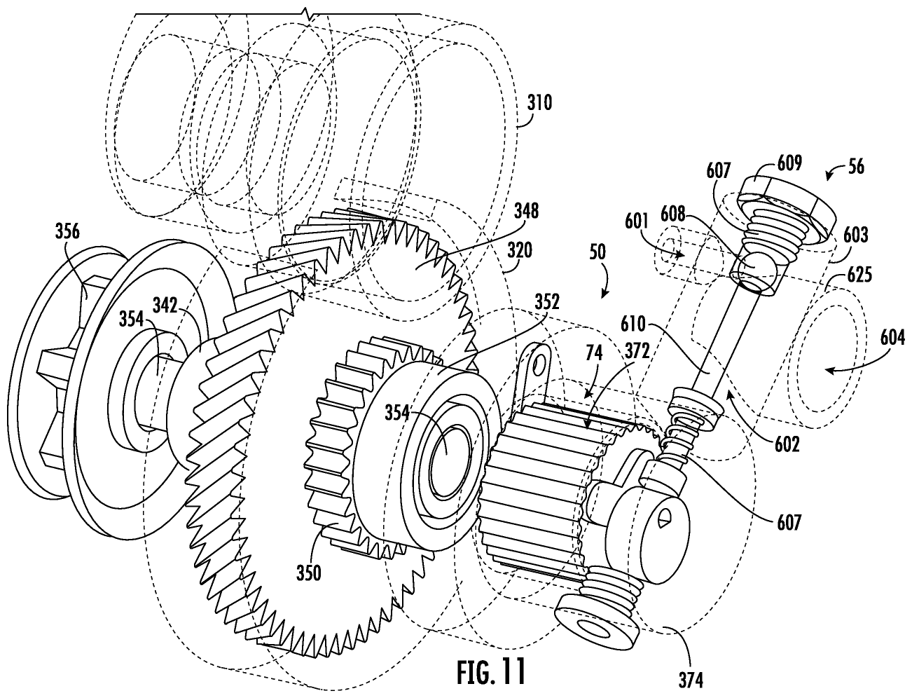

Referring now to FIGS. 11-12, perspective views of an exemplary embodiment of a lubrication system 50 are provided. In various embodiments, the lubrication system 50 includes a pump assembly 56 operably coupled to the drive system 300 to receive motive force for operating the pump assembly 56.

The pump assembly 56 is configured to suck, pull, or otherwise remove lubricant from a lubricant reservoir 52, such as further described below. As described further herein, the reservoir 52 may be formed of a compliant material allowing for reservoir 52 to compress or squeeze as the pump assembly 56 removes lubricant from the reservoir 52.

A gear assembly 74 having a plurality of gears operably couples the pump assembly 56 to the output shaft 354. The transmission system 338 may include a gear 350 (e.g., third gear) at the output shaft 354 operably coupled to the gear assembly 74 transmit energy from the motor 34 to drive the pump assembly 56. The gear 350 may form a compound gear at the output shaft 354 co-rotational with the second gear 348. In some embodiments, one or more gears 376 (e.g., fourth gear) may be positioned between the third gear 350 and the plurality of gears 372 at the gear assembly 74. In other embodiments the gear 350 may mesh directly with gears 372 at the gear assembly 74.

The gear assembly 74 may form a planetary gearbox configured to drive the pump assembly 56 at one or more desired speeds. In some embodiments, the gear assembly 74 is a three-stage planetary gear assembly. The plurality of gears 372 may be positioned along a rotational axis 375 (e.g., third rotational axis; FIG. 4) separate from the first, second, or third rotational axes 341, 355, 225. However, it should be appreciated that the rotational axis 375 may be co-axial to one or more of the rotational axes 341, 355, 225. The rotational axis 375 may be parallel to one or more of the rotational axes 341, 355, 225.

Referring briefly back to FIGS. 4-6, the third gear 350 is positioned within the output housing 320. For instance, the third gear 350 may be positioned alongside the second gear 348, such as to form the second and third gears 348, 350 as a compound gear. Referring to FIGS. 11-12, the gear assembly 74 may further include a gear housing 374 surrounding the plurality of gears 372. The gear housing 374 may be assembled or fastened to a pump body 603 of the pump assembly 56 to form a unitary component, or formed together as an integral, monolithic component as the pump body 603, such as may be formed via additive manufacturing, forging, a machining process, or combinations thereof. The gear housing 374 may be formed as a separable component from the output housing 320 or as an integral component to the output housing 320. The second and third gears 348, 350 may be fluidly sealed along with the gear assembly 74, such as within housings 320, 374 and seals 342.

Embodiments of the gear assembly 74 and drive system 300 provided herein may beneficially allow the gear assembly 74 to receive and contain the same lubrication as the transmission system 338. Embodiments provided herein may integrate the gear assembly 74, the pump assembly 56, and the drive system 300 to provide for a more compact, lighter-weight configuration. Additionally, embodiments of the pump assembly 56 provided herein are allowed to articulate with the output shaft 354 and output drive 356, such as based on articulation of the second gear 348 such as described herein. For instance, the pump assembly 56 may articulate along the circumferential direction 353 such as described herein.

Accordingly, embodiments of the pump assembly 56 may include a lubricant inlet 604 and a lubricant outlet 601 that may advantageously articulate as desired by the user. Additionally, or alternatively, embodiments of the pump assembly 56 may be clocked or rotated along a circumferential direction 377 relative to rotational axis 375, such as to allow the pump assembly 56, or the inlet 604 or outlet 601 thereof, to be beneficially positioned as desired to facilitate ergonomic positioning relative to the user, to improve flow to the chain 30, or improve entry or egress of lubricant through the pump assembly 56.

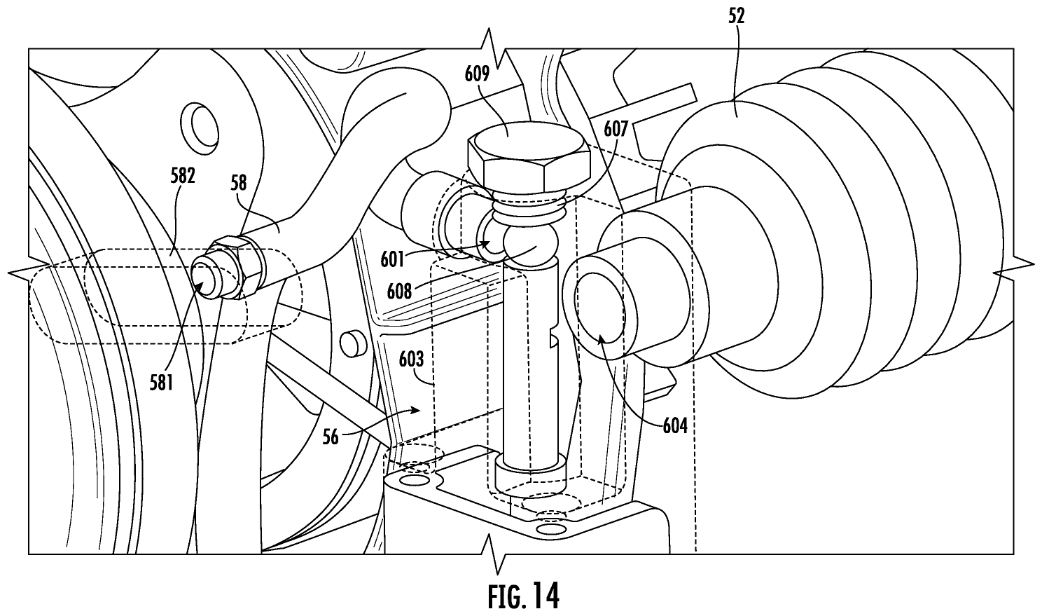

For instance, referring to FIG. 12, embodiments of the chainsaw 10 may include a lubricant port 378 configured to receive a flow of lubricant from the pump assembly 56. A tube, hose, manifold, or other appropriate conduit 58 (FIG. 14), such as a flexible conduit, may fluidly connect the lubricant outlet opening 601 to the lubricant port 378. For instance, the lubricant port 378 may be positioned at the frame 36 proximate to the guide bar 26, such as to allow for lubricant to pass from the pump assembly 56 through the lubricant port 378 to lubricant the chain 30 at the guide bar 26.

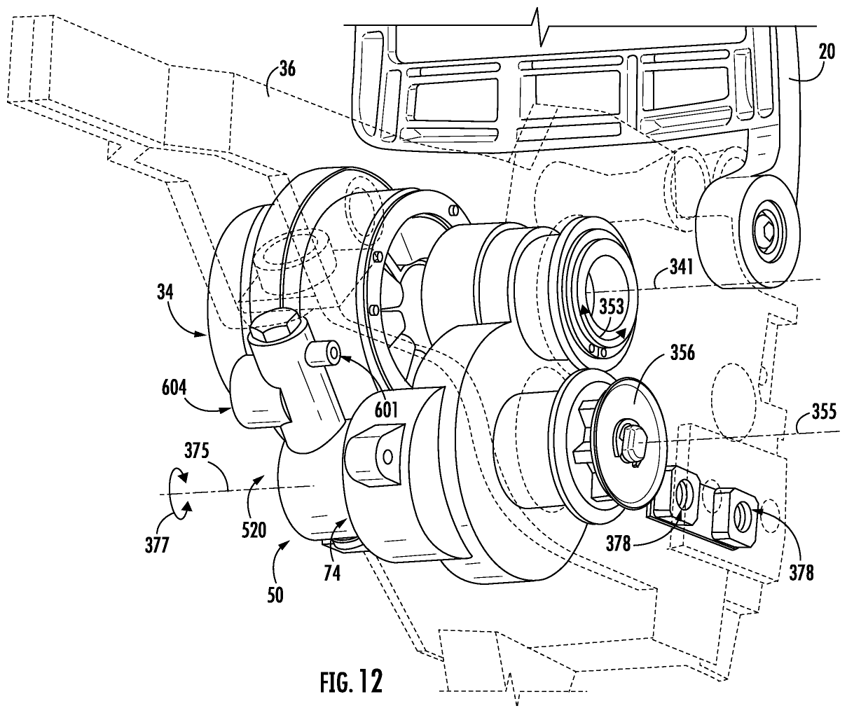

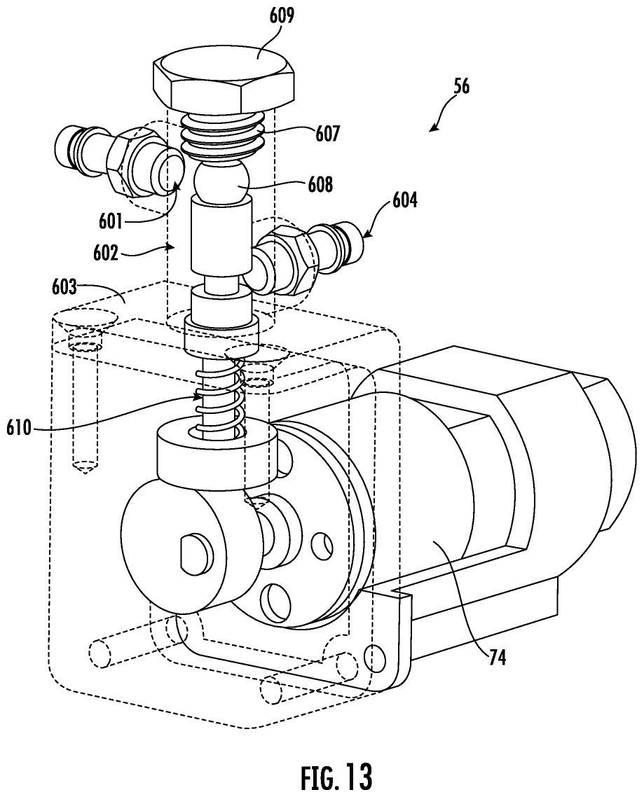

Referring now to FIG. 11 and FIGS. 13-14, in various embodiments, the pump assembly 56 includes a pump body 603 forming a pump inlet 604 in fluid communication with the lubricant reservoir 52. In some embodiments, passage walls 606 at the pump body 603 may form a nozzle or converging structure at the pump inlet 604. The converging structure may promote suction, egress, or generating a pressure differential to remove lubricant from the reservoir 52.

The pump assembly 56 may include one or more springs 607 configured to promote or allow articulation of the pump assembly 56. In certain embodiments, the pump assembly 56 includes a pump shaft 610 including a piston and configured to drive lubricant from the reservoir 52 through the outlet opening 601. Lubricant passing through the outlet opening 601 is delivered to the guide bar 26, track 28, or chain 30, or combinations thereof, for application. In some embodiments, the pump assembly 56 may include one or more valves 608. The valve 608 may form a wall, a vane, or a ball configured to desirably or selectively allow or restrict fluid flow. In some embodiments, valve 608 is configured to interface at outlet opening 601, such as to selectively allow flow of lubricant through pump assembly 56 through to conduit 58.

In some embodiments, the pump assembly 56 includes a fastener 609 extending to pump shaft 610. The fastener 609 may include any appropriate threaded body, such as a threaded shaft, such as a bolt, a screw, a tie rod, etc., or other structure allowing for selective compression and positioning of one or more springs 607 or valve 608. In some embodiments, a user may loosen or tighten, or otherwise articulate, the fastener 609 to adjust a position or articulation of the valve 608. For instance, a position of the fastener 609 relative to the body 603 may be adjusted to adjust a magnitude of compression of the spring 607. The spring 607 may interface with the valve 608. Accordingly, tightening or loosening of the fastener 609 may adjust compression or tension at the spring 607 such as to adjust a frequency of the valve 608 opening or closing the outlet opening 601, such as to adjust an amount or flow rate of lubricant into the conduit 58 and to the guide bar 26, track 28, or chain 30, or combinations thereof.

The conduit 58 includes a conduit outlet 581 configured to interface with the lubricant port 378 (FIG. 12) through which lubricant is allowed to egress onto the guide bar 26, the track 28, the chain 30, or combinations thereof.

Referring now to FIG. 15, an embodiment of a portion of a chainsaw 10 in accordance with aspects of the present disclosure is provided. The chainsaw 10 may include a lubricant dispenser 582 positioned in fluid communication with the conduit 58 and the lubricant port 378. The lubricant dispenser 582 may be configured to receive lubricant from the reservoir 52 through the pump assembly 56 and conduit 58, such as described above. In some embodiments, the lubricant dispenser 582 may receive lubricant that is provided from the conduit 58 to the guide bar 26, the track 28, or the chain 30, or combinations thereof, or receive an excess amount of lubricant that is provided from the conduit 58. In other embodiments, the lubricant dispenser 582 may form a guide track through which the guide bar 26 is extended. The lubricant dispenser 582 may receive lubricant from the conduit 58 and provide surfaces at which the lubricant can build up and be received at the guide bar 26, the track 28, or the chain 30.

Embodiments of the lubrication system 50 depicted and described herein are configured to flow, pump, or otherwise provide a lubricant to the guide bar 26, track 28, chain 30, or combinations thereof. In various embodiments, the lubrication system 50 is configured to flow a wax-based lubricant or grease-based lubricant. In still various embodiments, the lubrication system 500 is configured to flow an oil-based lubricant. The lubrication system 50 may include a dispensing apparatus including a reservoir 52 at which the lubricant is contained. The reservoir 52 may include a plastic container, such as including polyethylene or other appropriate material, from which lubricant may be extruded. Referring briefly to FIGS. 16A-16B, the reservoir 52 may form a manifold 521, such as a bag, ribbed structure, or bellows, that may contract, collapse, or deform, such as to promote extrusion of lubricant from the reservoir 52 as further described herein. For instance, reservoir 52 may form a ribbed structure or bellows configured to expand or contract, such as in accordion-type manner, such as may reduce a volume within the reservoir 52 and squeeze or otherwise promote egress of lubricant from within the reservoir 52. Reservoir 52 may form a closed end 522 and an open end 523 separated along a lateral axis. The open end 523 may particularly form an opening 524 through which lubricant egresses, such as further described herein. Open end 523 may further form an attachment interface 525 at which the reservoir 52 is connectable to the pump assembly 56, such as further described herein.

In certain embodiments, attachment interface 525 forms a thread configured to interface with a corresponding attachment surface 561 at the pump assembly 56 or transition body 611. However, it should be appreciated that attachment interface 525 and the corresponding attachment surface 561 may form a fitted interface, such as a press-fit, snap-fit, interference-fit, or other type of fit configured to desirably and releasably attach to the pump assembly 56 or transition body 611. The reservoir may be refillable, replaceable, and/or disposable.

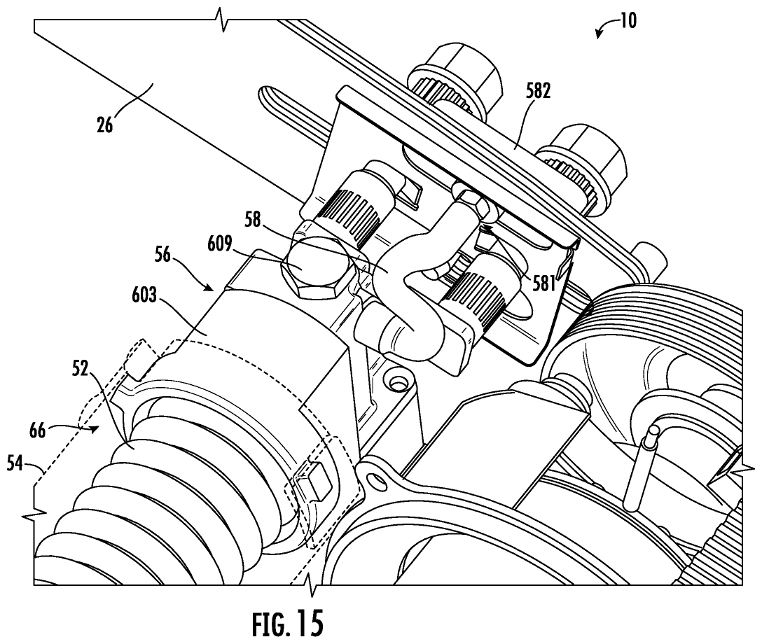

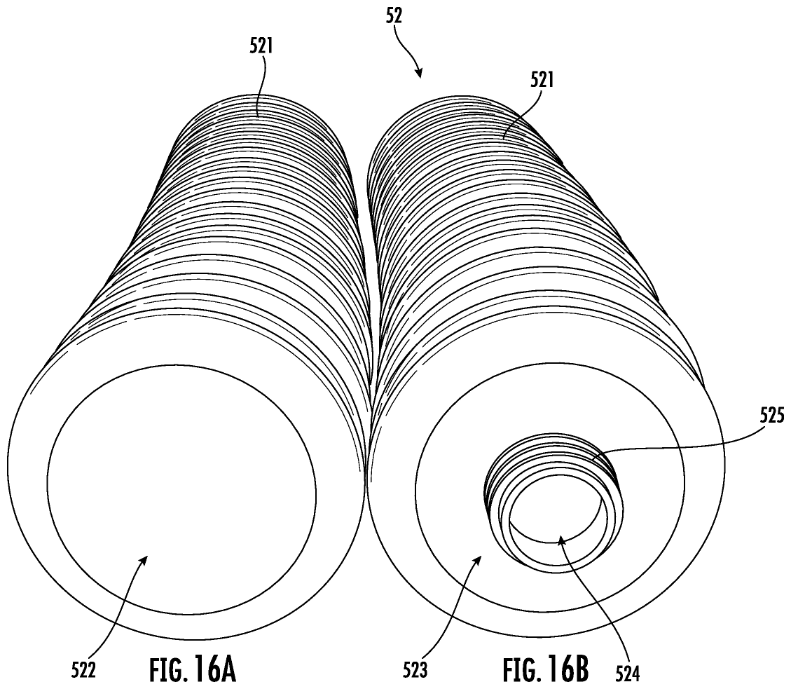

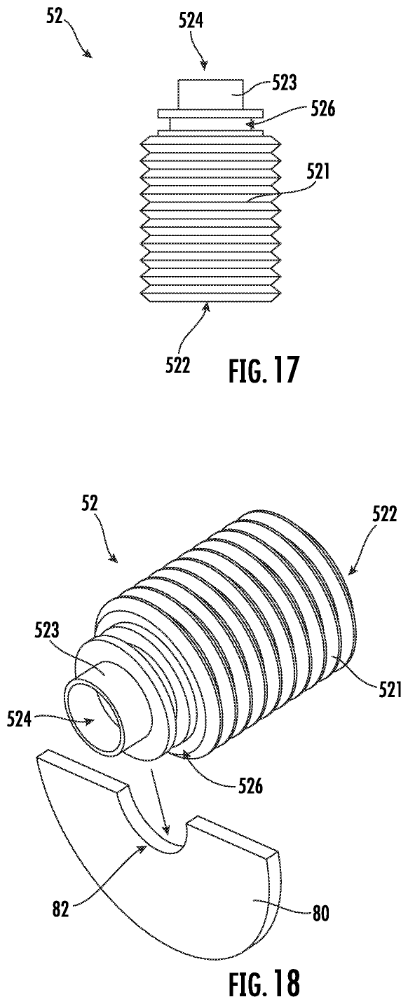

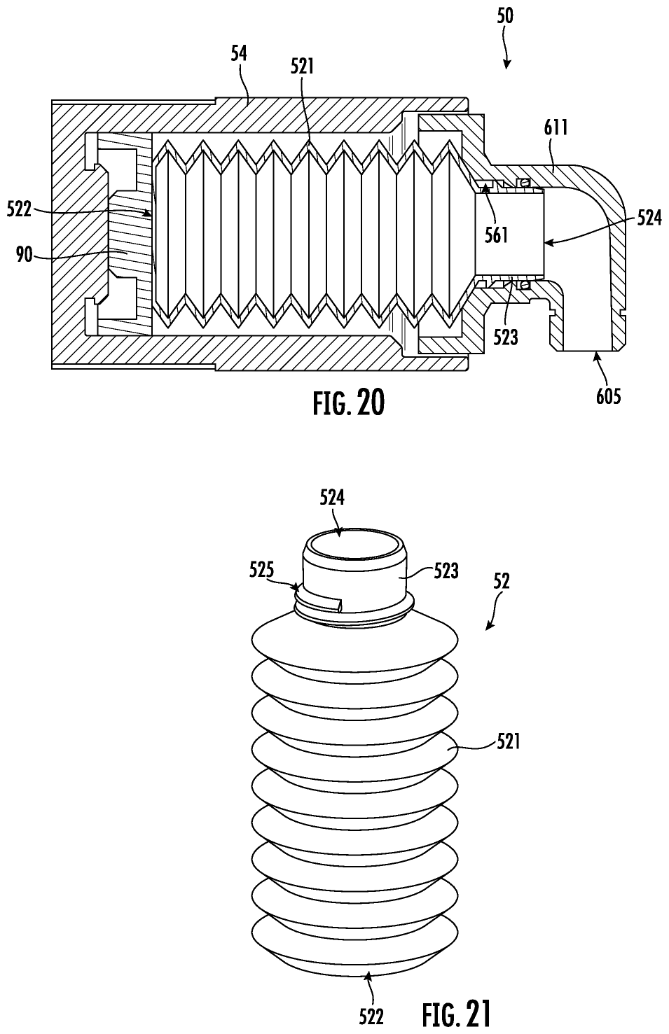

Referring to FIGS. 16A-16B and FIGS. 17-21, various embodiments of the reservoir 52 in accordance with aspects of the present disclosure are provided. The reservoir 52 may be positioned within a reservoir housing 54 (FIG. 15). The reservoir housing 54 may form a resilient or hardened casing surrounding the reservoir 52. The reservoir housing 54 may form a substantially cylindrical wall formed to surround the reservoir 52. The reservoir housing 54 may accordingly provide a protective layer surrounding the reservoir 52. In some embodiments, the reservoir housing 54 forms a resilient hardened layer relative to the compliant material of the reservoir 52.

The reservoir 52 may form a receiving interface 526, such as a neck, between the manifold 521 and the open end 523, such as a neck or conduit forming opening 524. The receiving interface 526 may be formed between walls forming stops or detents. The open end 523 may form a neck having a cylindrical or tapered geometry. The open end 523 may form, at least in part, a quick-disconnect fitting, such as a grease fitting or Zerk fitting. One or more seals positioned at the open end 523, such as, but not limited to, O-rings, rope seals, epoxy, putty, or other sealant material. A plate 80 may form the positioning interface 82 at which the receiving interface 526 may be placed by a user. The plate 80 may form the positioning interface 82 as a notch, groove, or indentation extending into the plate 80 to allow the reservoir 52 to position at the plate 80.

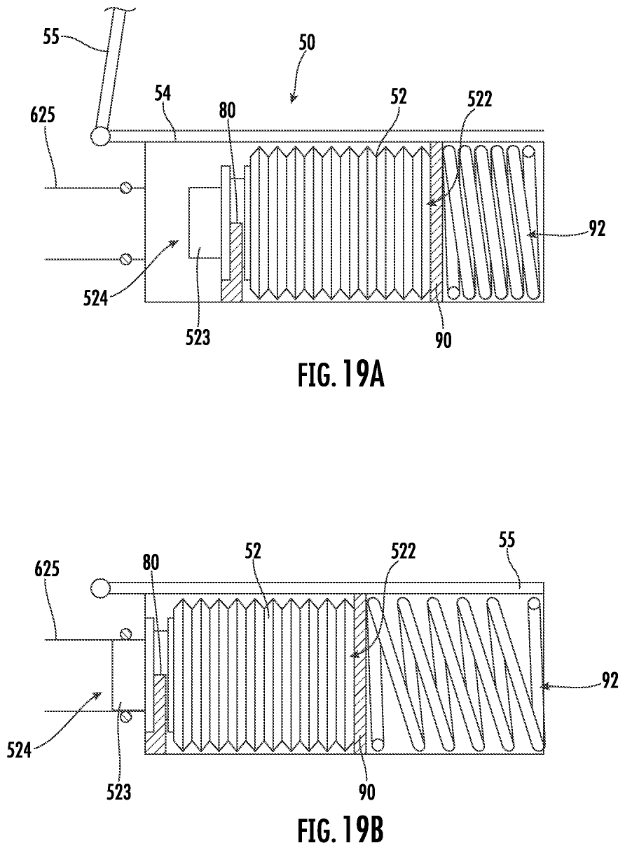

Referring to FIGS. 19A-19B, side views of exemplary embodiments of a portion of the lubrication system 50 are provided. The plate 80 may be positioned within the reservoir housing 54, such as to provide support to the reservoir 52 within the reservoir housing 54. In some embodiments, a spring 92 is positioned within the reservoir housing 54. The spring 92 is configured to exert a force to push the reservoir 52 toward the opening 524. FIG. 19a depicts a first position in which the spring 92 is in a compressed position and a lid 55 is in an open position, such as when a user places the reservoir 52 into the reservoir housing 54. FIG. 19B depicts a second position in which the spring 92 is in an extended position and the lid 55 is in a closed position.

In some embodiments, the reservoir housing 54 forms a cylinder that may releasably attach to the pump body 603 and surrounding the reservoir 52. In still some embodiments, the reservoir housing 54 may include the lid 55 forming an articulatable wall (e.g., pivoting, sliding, translating, or removable wall), allowing for selective access into the reservoir housing 54 at which the reservoir 52 is positioned.

In still some embodiments, a spring plate 90 is positioned between the spring 92 and the reservoir 52, such as to provide a surface at which force from the spring 92 may distribute to the reservoir 52 (e.g., the closed end 522 of the reservoir 52). The plate 80 may be configured to slide along a direction of force from the spring 92 to the reservoir 52. As such, the plate 80 may act as a guide to position the open end 523 into the pump body 603. Plate 80, interfacing surfaces at the reservoir housing 54, or both, may be configured to allow or facilitate sliding of the plate 80 such as described above, such as, but not limited to, low-friction materials or coatings, grooves, or recesses.

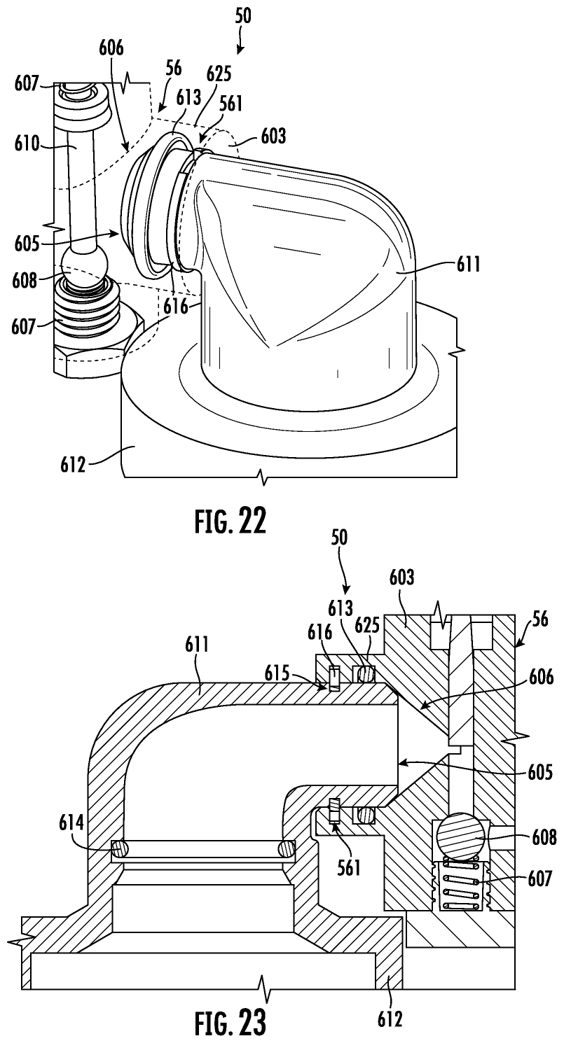

FIG. 22 provides a perspective view of a portion of an embodiment of the lubrication system 50. FIG. 23 provides a side cross-sectional view of a portion of an embodiment of the lubrication system 50. In various embodiments, the lubrication system 50 includes a transition body 611 configured to receive the reservoir 52 and positioned fluidly between the reservoir 52 and the inlet 604 of the pump assembly 56. The transition body 611 may form any appropriate flowpath geometry, such as, but not limited to, an L-shaped turn, a straight pipe, a serpentine structure, a U-bend, or other appropriate flowpath geometry. The transition body 611 forms an outlet opening 605 configured to extend through inlet 604 at the pump body 603. The transition body 611 may include a retainer 612 configured to receive the reservoir 52. A seal 614, such as an O-ring, may be positioned at a first end at which the attachment interface 525 of the reservoir 52 is received through the retainer 612. A seal 613, such as an O-ring, may be positioned at a second end at which the transition body 611 is received at the pump body 603, such as at the inlet 604.

In some embodiments, the transition body 611 includes a spiral-type retaining ring 616 configured for inner diameter (ID) and outer diameter (OD) locking to provide concealed fastening. For instance, the transition body 611 may include a groove 615 configured to receive the retaining ring 616. The attachment surface 561 at a neck 625 extending from the pump body 603 may form a groove corresponding to the groove 615 at the transition body 611, such as to receive at least a portion of the retaining ring 616. For instance, such as depicted in FIGS. 22-23, the retaining ring 616 may form a spiral, partial-circle, or split-ring body extendable into the attachment surface 561 forming a groove at the neck 625 and extendable into the groove 615 at the transition body 611. The retainer ring 616 may form a spring such that ring 616 may compress into the groove 615 during assembly into the neck 625 and expand into the attachment surface 561. The retainer ring 616 may lock the transition body 611 to the neck 625. The seal 613 may further mitigate leakage between the transition body 611 and the neck 625.

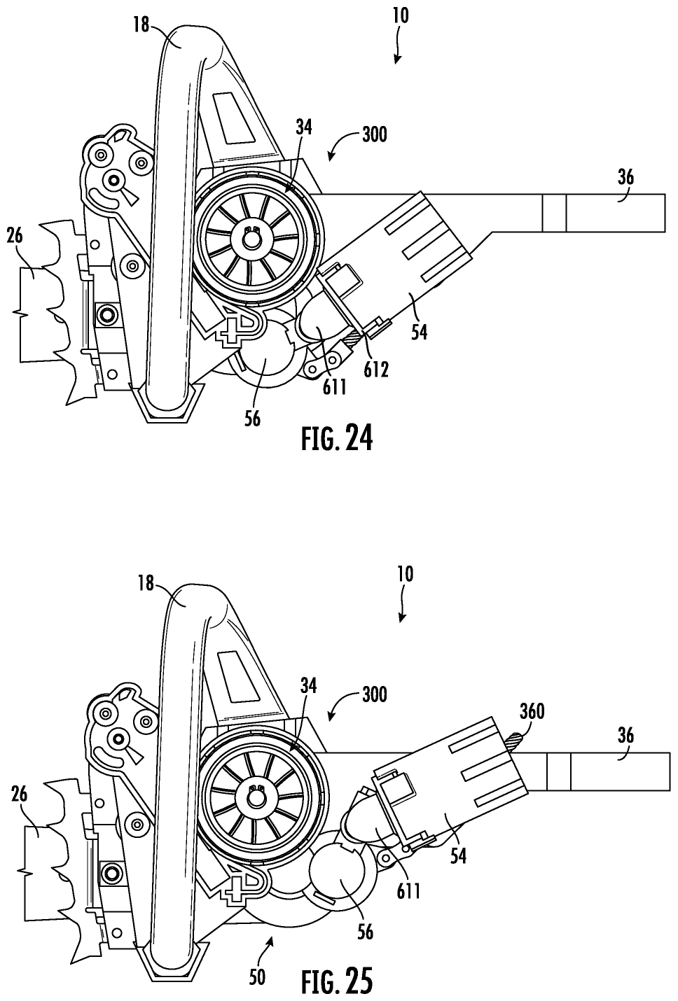

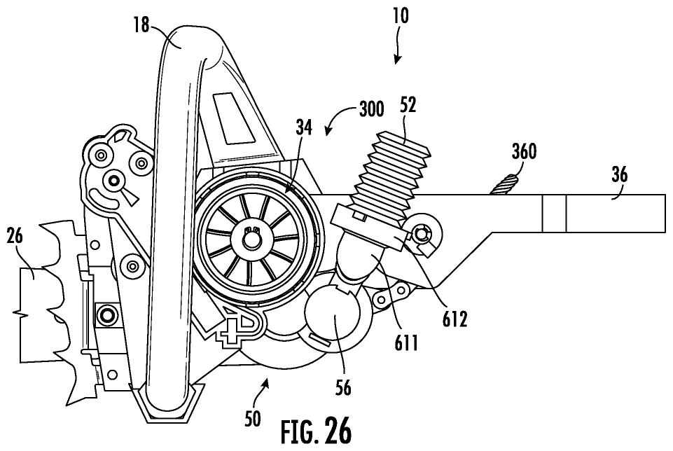

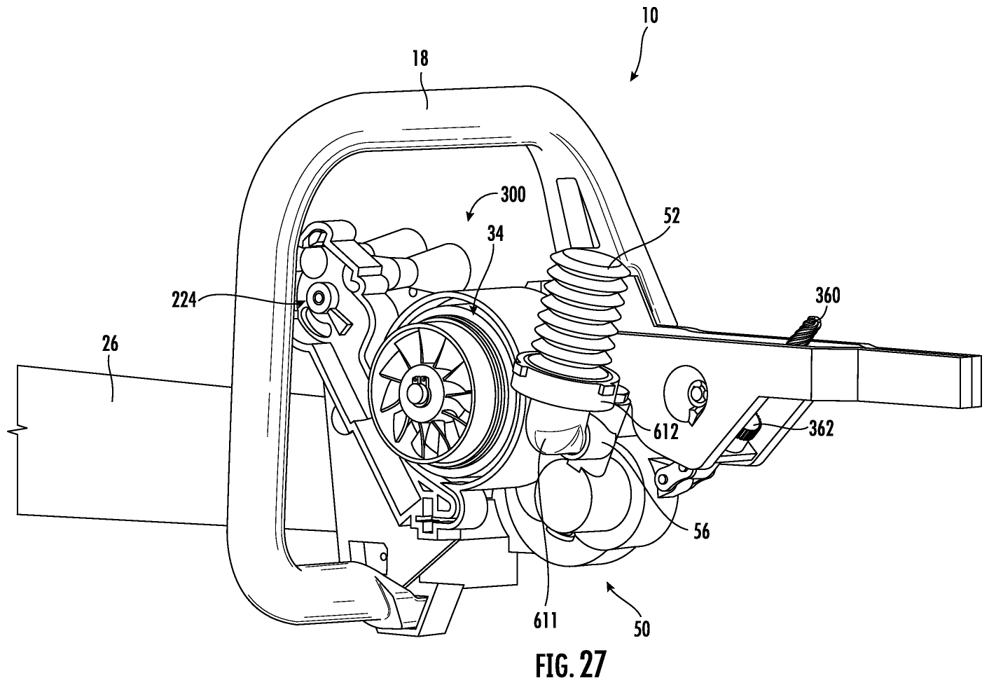

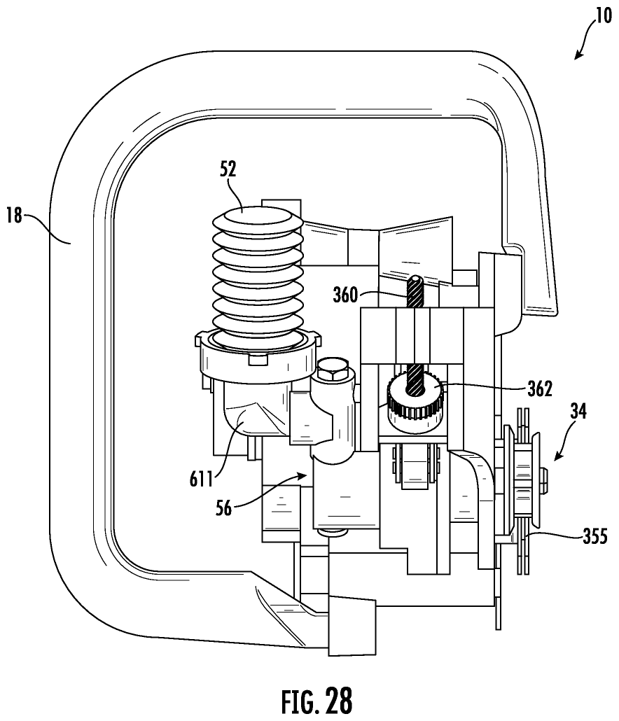

Referring now to FIGS. 24-28, views of various positions of the lubrication system 50 are provided. The lubrication system 50 may be configured to translate forward (e.g., proximate to handle 18, such as depicted in FIG. 24) to rear (e.g., distal to handle 18, such as depicted in FIG. 25). In some embodiments, the lubrication system 50 may be coupled to a swivel gear assembly allowing the lubrication system 50 to translate or rotate forward and rear. In still some embodiments, the pump assembly 56 may be rotatable. For instance, referring to FIGS. 25-28, the reservoir 52 and reservoir housing 54 may be rotatable from a lesser first angular position (such as depicted in FIG. 25) to a greater second angular position (such as depicted in FIGS. 26-28), such as via embodiments of the drive system 300 described herein. Various positionings of the lubrication system 50, or portions thereof, may facilitate access, attachment, removal, and replacement of the reservoir 52.

Embodiments of the chainsaw 10 provided herein may utilize a wax or grease lubricant at the guide bar 26, the track 28, or the chain 30, such as to reduce mess, drippage, pollution, debris, or visual untidiness associated with oil lubricants. The reservoir 52 may include a bag or bellows container forming a removable, disposable package containing the wax or grease lubricant or the reservoir itself may be disposable or replaceable. The reservoir 52 may attach directly to the pump assembly 56, or indirectly through the transition body 611 or other connecting interface. In various embodiments, the lubricant is any appropriate wax or grease, such as may include low temperature pumpability, resistance to dripping or other forms of dispersing during high temperature storage, and low bar wear. Embodiments of the chainsaw 10 provided herein may further improve durability, reduce wear, or reduce material loss or deformation at the guide bar 26, the track 28, or the chain 30, or combinations thereof.

Embodiments of the drive system 300 may provide a compact, lightweight, chainsaw 10. For instance, the drive system 300 may facilitate easy tensioning at the tensioner mechanism 330. The drive system 300 may allow for an integrated lubrication system 50 for the transmission system 338 and gear assembly 74, such as to allow for the same lubricant to be utilized. The drive system 300 may further translate output from the motor 34 to a desired torque and speed for operating the pump assembly 56 at one or more speeds more suitable for improved performance at the pump assembly 56. The improved speeds may particularly provide operational ranges for displacing a wax or grease lubricant from the reservoir 52 in contrast to oil or lower-viscosity lubricants. However, it should be appreciated that embodiments of the chainsaw 10 and drive system 300 may be configured to provide operational ranges for displacing an oil, oil-based, or other lower-viscosity lubricant from the reservoir 52.

Further aspects of the present disclosure are provided in one or more of the following clauses:
1. A chainsaw, the chainsaw including a guide bar extending from a housing, wherein the guide bar includes a track extending around a perimeter of the guide bar configured to receive a chain; a lubrication system including a reservoir at which a lubricant is contained, wherein the reservoir is releasably attachable to a pump assembly, the pump assembly including a body at which a pump apparatus is positioned, wherein the pump apparatus forms a pump inlet in fluid communication with the reservoir, and wherein the pump assembly forms an outlet opening at which a conduit is fluidly coupled to receive the lubricant, the conduit forming a conduit outlet through which the lubricant is provided to the guide bar.
2. The chainsaw of any one or more clauses herein, wherein the lubricant is a wax lubricant or a grease lubricant.
3. The chainsaw of any one or more clauses herein, the chainsaw including a motor operably coupled to the chain to drive the chain at the guide bar.
4. The chainsaw of any one or more clauses herein, the chainsaw including a drive system operably coupled to the pump assembly to actuate the pump apparatus.
5. The chainsaw of any one or more clauses herein, wherein the drive system includes a second motor operably coupled to the pump assembly to actuate the pump apparatus.
6. The chainsaw of any one or more clauses herein, wherein the drive system includes a gear system operably coupled to the motor to transmit power to the pump assembly to actuate the pump apparatus.
7. The chainsaw of any one or more clauses herein, wherein the reservoir extends from the pump assembly perpendicular or oblique to a longitudinal extension of the guide bar.
8. The chainsaw of any one or more clauses herein, wherein the reservoir includes an attachment interface at an open end, the attachment interface forming a threaded interface releasably attachable to a corresponding attachment surface at the pump assembly.
9. The chainsaw of any one or more clauses herein, the chainsaw including a reservoir housing surrounding the reservoir; and a fitting at which the reservoir housing is attachable, wherein the fitting and housing together form a locking interface configured to selectively secure the reservoir housing to the fitting.
10. The chainsaw of any one or more clauses herein, wherein the locking interface forms a twist lock, a bayonet fitting, a threaded interface, a tapered fitting, a quick-disconnect fitting, a tapered fitting, a grease fitting, or a Zerk fitting.
11. The chainsaw of any one or more clauses herein, wherein the fitting is coupled to the body of the pump assembly.
12. The chainsaw of any one or more clauses herein, wherein the reservoir includes a compliant material allowing the reservoir to compress.
13. The chainsaw of any one or more clauses herein, wherein the reservoir includes a polyethylene material.
14. The chainsaw of any one or more clauses herein, wherein the reservoir includes a bellows configured to contract to reduce a volume within the reservoir.
15. A lubrication system, the lubrication system including a pump assembly including a body at which a pump apparatus is positioned, wherein the pump apparatus forms a pump inlet configured to be in fluid communication with a releasably attachable reservoir in which a lubricant is contained, and wherein the pump assembly forms an outlet opening at which a conduit is fluidly coupled to receive the lubricant to flow through a conduit outlet.
16. The lubrication system of any one or more clauses herein, wherein the lubricant is a wax lubricant or a grease lubricant.
17. The lubrication system of any one or more clauses herein, wherein the reservoir includes an attachment interface at an open end, the attachment interface forming a threaded interface releasably attachable to a corresponding attachment surface at the pump assembly.
18. The lubrication system of any one or more clauses herein, the lubrication system including a reservoir housing surrounding the reservoir; and a fitting at which the reservoir housing is attachable, wherein the fitting and housing together form a locking interface configured to selectively secure the reservoir housing to the fitting.
19. The lubrication system of any one or more clauses herein, wherein the locking interface forms a twist lock, a bayonet fitting, a threaded interface, a tapered fitting, a quick-disconnect fitting, a tapered fitting, or a grease fitting.
20. The lubrication system of any one or more clauses herein, wherein the fitting is coupled to the body of the pump assembly.
21. The lubrication system of any one or more clauses herein, wherein the reservoir includes a compliant material allowing the reservoir to compress.
22. The lubrication system of any one or more clauses herein, wherein the reservoir includes a polyethylene material.
23. The lubrication system of any one or more clauses herein, wherein the reservoir includes a bellows configured to contract to reduce a volume within the reservoir.
24. The lubrication system of any one or more clauses herein, the chainsaw including a drive system operably coupled to the pump assembly to actuate the pump apparatus.
25. The lubrication system of any one or more clauses herein, wherein the drive system includes a motor operably coupled to the pump assembly to actuate the pump apparatus.
26. The lubrication system of any one or more clauses herein, wherein the drive system includes a gear system operably coupled to the motor to transmit power to the pump assembly to actuate the pump apparatus.
27. The lubrication system of any one or more clauses herein, the lubrication system including a transition body positioned between a neck extending from the body and the reservoir, the transition body including a groove configured to receive a retaining ring, the neck including an attachment surface configured to receive the retaining ring, wherein the retaining ring is configured to position into the groove and the attachment surface to couple the transition body to the neck.
28. A lubricant for a chainsaw, the lubricant including a wax lubricant or a grease lubricant.
29. The lubricant of any one or more clauses herein, wherein the lubricant includes a low temperature pumpability and resistance to high temperature dispersing.
30. The chainsaw of any one or more clauses herein, the lubrication system including a transition body positioned between a neck extending from the body and the reservoir, the transition body including a groove configured to receive a retaining ring, the neck including an attachment surface configured to receive the retaining ring, wherein the retaining ring is configured to position into the groove and the attachment surface to couple the transition body to the neck.
31. A chainsaw, the chainsaw including a guide bar configured to receive a chain; and a drive system including a motor operably coupled to drive a motor shaft and an output drive operably coupled to an output shaft, wherein the motor shaft and the output shaft are mechanically coupled to one another by a transmission system to transfer energy from the motor to the output drive, wherein the motor and motor shaft are coupled to a first housing, wherein the transmission system allows the output shaft to selectively change positions along a circumferential direction relative to a rotational axis of the motor shaft to selectively loosen or tighten a connection of the output drive to the chain at the guide bar.
32. The chainsaw of any one or more clauses herein, wherein the motor shaft and the output shaft are positioned at separate planes and extending parallel to one another.
33. The chainsaw of any one or more clauses herein, the drive system including a first motor shaft bearing coupled to the motor shaft and the first housing; and a second motor shaft bearing coupled to the motor shaft and a second housing.
34. The chainsaw of any one or more clauses herein, the drive system including an output shaft bearing coupled to the output shaft and the second housing.
35. The chainsaw of any one or more clauses herein, the transmission system including a plurality of gears operably connecting the motor shaft to the output shaft.
36. The chainsaw of any one or more clauses herein, wherein the plurality of gears forms a compound gear assembly.
37. The chainsaw of any one or more clauses herein, wherein the plurality of gears forms a reduction gear assembly, the reduction gear assembly including between a 1.5:1 gear reduction and a 3:1 gear reduction.
38. The chainsaw of any one or more clauses herein, wherein the plurality of gears is positioned at a second housing.
39. The chainsaw of any one or more clauses herein, the transmission system including a first gear coupled to the motor shaft; a second gear coupled to the output shaft, wherein the first gear and the second gear are meshed to one another.
40. The chainsaw of any one or more clauses herein, the transmission system including a third gear coupled to the output shaft, wherein the third gear is co-rotational with the second gear.
41. The chainsaw of any one or more clauses herein, the chainsaw including a frame at which the guide bar and the first housing are attached, wherein the first housing and the rotational axis of the motor shaft is fixed relative to the frame, and wherein the output shaft is allowed to selectively change positions along the circumferential direction relative to the rotational axis of the motor shaft.
42. The chainsaw of any one or more clauses herein, the chainsaw including a tensioner mechanism including a plurality of drive accessories operably coupling a knob to a second housing to actuate the second housing along the circumferential direction relative to a rotational axis of the motor shaft.
43. The chainsaw of any one or more clauses herein, wherein the plurality of drive accessories forms a worm gear, worm shaft, and lead screw configured to translate rotational movement of the knob to rotation of the second housing along the circumferential direction.
44. The chainsaw of any one or more clauses herein, the chainsaw including a lubrication system including a reservoir at which a lubricant is containable, the lubrication system including a pump assembly at which the reservoir is releasably attachable to the pump assembly; a gear assembly operably coupling the lubrication system to the transmission system to transmit energy from the motor to drive the pump assembly.
45. The chainsaw of any one or more clauses herein, wherein selectively changing positions of the output shaft along the circumferential direction relative to the rotational axis of the motor shaft changes a position of the lubrication system along the circumferential direction.
46. The chainsaw of any one or more clauses herein, the pump assembly including a pump body, the pump body including an inlet at which the reservoir is selectively attachable to provide a lubricant to the pump body, the pump body including an outlet through which the lubricant is provided to the guide bar through a conduit attached to the outlet.
47. A drive system for a chainsaw, the drive system including a motor shaft, wherein the motor shaft is configured to rotate relative to a first rotational axis extending through the motor shaft; a motor operably coupled to drive the motor shaft; a first housing, wherein the motor and the motor shaft are operably coupled to the first housing; an output shaft, wherein the output shaft is configured to rotate relative to a second rotational axis extending through the output shaft, wherein the output shaft is separate from the motor shaft; an output drive operably coupled to the output shaft; and a transmission system, wherein the motor shaft and the output shaft are operably coupled to one another by the transmission system to transfer energy from the motor to the output drive, wherein the transmission system allows the second rotational axis at the output shaft to selectively change positions along a circumferential direction relative to the first rotational axis of the motor shaft.
48. The drive system of any one or more clauses herein, the drive system including a first motor shaft bearing coupled to the motor shaft and the first housing; and a second motor shaft bearing coupled to the motor shaft and a second housing.
49. The drive system of any one or more clauses herein, the drive system including an output shaft bearing coupled to the output shaft and the second housing.
50. The drive system of any one or more clauses herein, the transmission system including a first gear coupled to the motor shaft, the first gear co-rotational with the motor shaft relative to the first rotational axis; a second gear coupled to the output shaft, the second gear co-rotational with the output shaft relative to the second rotational axis, wherein the first gear is operably coupled to transmit energy to the output shaft through the second gear.
51. The drive system of any one or more clauses herein, the transmission system including a plurality of gears operably connecting the motor shaft to the output shaft.
52. The drive system of any one or more clauses herein, wherein the motor shaft and the output shaft are positioned at separate planes and extending parallel to one another.
53. The drive system of any one or more clauses herein, wherein the transmission system includes a plurality of gears forming a compound gear assembly.
54. The drive system of any one or more clauses herein, wherein the transmission system includes a plurality of gears forming a reduction gear assembly, the reduction gear assembly including between a 1.5:1 gear reduction and a 3:1 gear reduction.
55. The drive system of any one or more clauses herein, wherein the transmission system includes a plurality of gears positioned at a second housing.
56. A chainsaw, the chainsaw including a guide bar configured to receive a chain; and a drive system including a motor operably coupled to drive a motor shaft and an output drive operably coupled to an output shaft, wherein the motor shaft and the output shaft are mechanically coupled to one another by a transmission system to transfer energy from the motor to the output drive, wherein the motor and motor shaft are coupled to a first housing, wherein the transmission system allows the output shaft to selectively change positions along a circumferential direction relative to a rotational axis of the motor shaft to selectively loosen or tighten a connection of the output drive to the chain at the guide bar; and a braking mechanism including a collar extending around a rotatable component of the motor, the braking mechanism including a linkage assembly coupled to a pivot mechanism, wherein rotation of the pivot mechanism pulls the linkage assembly to cause the collar to clamp onto the rotational component of the motor to cease rotation.
57. A braking mechanism for a chainsaw, the braking mechanism including a collar extending around a rotatable component of a motor, the braking mechanism including a linkage assembly coupled to a pivot mechanism, wherein rotation of the pivot mechanism pulls the linkage assembly to cause the collar to clamp onto the rotational component of the motor to cease rotation.
58. The braking mechanism of any one or more clauses herein, wherein the linkage assembly includes a chain or belt coupled to the pivot mechanism.
59. The braking mechanism of any one or more clauses herein, wherein a linkage couples the pivot mechanism to the chain or belt to translate rotational movement of the pivot mechanism to linear movement of the belt to clamp the collar to the rotational component of the motor.
60. The braking mechanism of any one or more clauses herein, wherein the collar includes a first material and the motor includes a second material different from the first material.
61. The braking mechanism of any one or more clauses herein, wherein the first material includes a steel or steel alloy material.
62. The braking mechanism of any one or more clauses herein, wherein the second material includes an aluminum or aluminum alloy material.
63. A chainsaw, the chainsaw including a guide bar configured to receive a chain; a motor; a lubrication system including a reservoir at which a lubricant is containable, the lubrication system including a pump assembly at which the reservoir is releasably attachable to the pump assembly at an inlet formed at a body, the lubrication system including a gear assembly operably coupled to drive a shaft positioned within the body, the body forming an outlet through which the lubricant is allowed to egress the body; and a transmission system operably coupled to transmit energy from the motor to the gear assembly at the lubrication system.
64. The chainsaw of any one or more clauses herein, the guide bar including a lubrication port configured to receive lubricant egressed from the outlet at the pump assembly.
65. The chainsaw of any one or more clauses herein, wherein the gear assembly is positioned a gear housing, and wherein lubricant received through the inlet at the body is in fluid communication with the gear assembly.
66. The chainsaw of any one or more clauses herein, wherein the gear housing and the body are coupled as a unitary component.
67. The chainsaw of any one or more clauses herein, wherein the gear housing and the body form an integral, monolithic component.
68. The chainsaw of any one or more clauses herein, the chainsaw including a housing at which the transmission system is positioned, the transmission system including a plurality of gears; and a seal configured to retain lubricant within a cavity, wherein the cavity extends from the seal to the pump assembly to encompass the plurality of gears and the gear assembly, wherein the cavity is in fluid communication with the inlet and the outlet at the pump assembly to provide lubricant to the plurality of gears and the gear assembly.
69. The chainsaw of any one or more clauses herein, wherein the cavity is in fluid communication with the inlet and the outlet at the pump assembly to provide lubricant to the plurality of gears, the gear assembly, and the lubrication port at the guide bar.
70. The chainsaw of any one or more clauses herein, the transmission system including a plurality of gears forming a compound gear assembly.
71. The chainsaw of any one or more clauses herein, the transmission system including a first gear coupled to a motor shaft operably coupled to the motor, the first gear co-rotational with the motor shaft relative to a first rotational axis; a second gear coupled to an output shaft, the second gear co-rotational with the output shaft relative to a second rotational axis, wherein the first gear is operably coupled to transmit energy to the output shaft through the second gear.
72. The chainsaw of any one or more clauses herein, the transmission system including a third gear coupled to the gear assembly, the third gear co-rotational with the output shaft relative to the second rotational axis.
73. The chainsaw of any one or more clauses herein, wherein the gear assembly is rotatable relative to a third rotational axis different from the first rotational axis and the second rotational axis.
74. The chainsaw of any one or more clauses herein, wherein the motor shaft, the output shaft, and the gear assembly are rotatable at different speeds relative to one another.
75. The chainsaw of any one or more clauses herein, wherein the lubricant is an oil-based lubricant, a wax-based lubricant, or a grease-based lubricant.
76. A drive system for a chainsaw, the drive system including a motor; a lubrication system including a reservoir at which a lubricant is containable, the lubrication system including a pump assembly at which the reservoir is releasably attachable to the pump assembly at an inlet formed at a body, the lubrication system including a gear assembly operably coupled to drive a shaft positioned within the body, the body forming an outlet through which the lubricant is allowed to egress the body; and a transmission system operably coupled to transmit energy from the motor to the gear assembly at the lubrication system.
77. The drive system of any one or more clauses herein, wherein the gear assembly is positioned a gear housing, and wherein lubricant received through the inlet at the body is in fluid communication with the gear assembly.
78. The drive system of any one or more clauses herein, wherein the gear housing and the body are coupled as a unitary component.
79. The drive system of any one or more clauses herein, wherein the gear housing and the body form an integral, monolithic component.
80. The drive system of any one or more clauses herein, the drive system including a housing at which the transmission system is positioned, the transmission system including a plurality of gears; and a seal configured to retain lubricant within a cavity, wherein the cavity extends from the seal to the pump assembly to encompass the plurality of gears and the gear assembly, wherein the cavity is in fluid communication with the inlet and the outlet at the pump assembly to provide lubricant to the plurality of gears and the gear assembly.
81. The drive system of any one or more clauses herein, the transmission system including a first gear coupled to a motor shaft operably coupled to the motor, the first gear co-rotational with the motor shaft relative to a first rotational axis; a second gear coupled to an output shaft, the second gear co-rotational with the output shaft relative to a second rotational axis, wherein the first gear is operably coupled to transmit energy to the output shaft through the second gear; and a third gear coupled to the gear assembly, the third gear co-rotational with the output shaft relative to the second rotational axis.
82. The drive system of any one or more clauses herein, wherein the motor shaft, the output shaft, and the gear assembly are rotatable at different speeds relative to one another.
83. The chainsaw of any one or more clauses herein including the drive system of any one or more clauses herein.
84. The chainsaw of any one or more clauses herein including the braking mechanism of any one or more clauses herein.
85. The chainsaw of any one or more clauses herein including the lubrication system of any one or more clauses herein.
86. The chainsaw of any one or more clauses herein including the lubricant of any one or more clauses herein.
87. The lubrication system of any one or more clauses herein including the lubricant of any one or more clauses herein.
88. The drive system of any one or more clauses herein including the lubricant of any one or more clauses herein.
89. A tensioner mechanism for a chainsaw, including a plurality of drive accessories operably coupling a knob to a second housing to actuate the second housing along the circumferential direction relative to a rotational axis of the motor shaft.
90. The tensioner mechanism of any one or more clauses herein, wherein the user interface is a knob assembly including a knob body, a lock wheel, and a ratchet mechanism.
91. The tensioner mechanism of any one or more clauses herein, wherein the knob body comprises a button configured to selectively engage a spring arm at the knob body to a plurality of teeth at the lock wheel.
92. The tensioner mechanism of any one or more clauses herein, wherein the ratchet mechanism includes a spring arm configured to engage a plurality of teeth at the knob body.
93. The tensioner mechanism of any one or more clauses herein, wherein the lock wheel is coupled to the ratchet mechanism to transfer torque from the knob body through the lock wheel and ratchet mechanism when a spring arm at the knob body engages a plurality of teeth at the lock wheel.
94. The tensioner mechanism of any one or more clauses herein, wherein plurality of drive accessories is operably coupled to the knob assembly.
95. The tensioner mechanism of any one or more clauses herein, the user interface including an anti-rotation body including a key, wherein the key is configured to engage a surface at a displaceable electrical power unit to inhibit rotation of the user interface.
96. The tensioner mechanism of any one or more clauses herein, wherein the user interface includes a knob body, a lock wheel, a ratchet mechanism, and an anti-rotation body in serial arrangement along a center axis.
97. The tensioner mechanism of any one or more clauses herein, the plurality of drive accessories forming a worm gear assembly configured to couple to the second housing to translate the second housing along a circumferential direction relative to the motor shaft.
98. The chainsaw of any one or more clauses herein including the tensioner mechanism of any one or more clauses herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A chainsaw, the chainsaw comprising:
a guide bar configured to receive a chain; and
a drive system comprising a motor operably coupled to drive a motor shaft and an output drive operably coupled to an output shaft, wherein the motor shaft and the output shaft are mechanically coupled to one another by a transmission system to transfer energy from the motor to the output drive, wherein the motor and motor shaft are coupled to a first housing, wherein the transmission system allows the output shaft to selectively change positions along a circumferential direction relative to a rotational axis of the motor shaft to selectively loosen or tighten a connection of the output drive to the chain at the guide bar.

2. The chainsaw of claim 1, wherein the motor shaft and the output shaft are positioned at separate planes and extending parallel to one another.

3. The chainsaw of claim 1, the drive system comprising:
a first motor shaft bearing coupled to the motor shaft and the first housing; and
a second motor shaft bearing coupled to the motor shaft and a second housing.

4. The chainsaw of claim 3, the drive system comprising:
an output shaft bearing coupled to the output shaft and the second housing.

5. The chainsaw of claim 1, the transmission system comprising a plurality of gears operably connecting the motor shaft to the output shaft.

6. The chainsaw of claim 5, wherein the plurality of gears forms a compound gear assembly.

7. The chainsaw of claim 5, wherein the plurality of gears forms a reduction gear assembly, the reduction gear assembly comprising between a 1.5:1 gear reduction and a 3:1 gear reduction.

8. The chainsaw of claim 5, wherein the plurality of gears is positioned at a second housing.

9. The chainsaw of claim 5, the transmission system comprising:
a first gear coupled to the motor shaft;
a second gear coupled to the output shaft, wherein the first gear and the second gear are meshed to one another.

10. The chainsaw of claim 9, the transmission system comprising:
a third gear coupled to the output shaft, wherein the third gear is co-rotational with the second gear.

11. The chainsaw of claim 1, the chainsaw comprising:
a frame at which the guide bar and the first housing are attached, wherein the first housing and the rotational axis of the motor shaft is fixed relative to the frame, and wherein the output shaft is allowed to selectively change positions along the circumferential direction relative to the rotational axis of the motor shaft.

12. The chainsaw of claim 1, the chainsaw comprising:
a tensioner mechanism comprising a plurality of drive accessories operably coupling a user interface to a second housing to actuate the second housing along the circumferential direction relative to a rotational axis of the motor shaft.

13. The chainsaw of claim 12, wherein the plurality of drive accessories forms a worm gear, worm shaft, and lead screw configured to translate rotational movement of the user interface to rotation of the second housing along the circumferential direction.

14. The chainsaw of claim 1, the chainsaw comprising:
a lubrication system comprising a reservoir at which a lubricant is containable, the lubrication system comprising a pump assembly at which the reservoir is releasably attachable to the pump assembly;
a gear assembly operably coupling the lubrication system to the transmission system to transmit energy from the motor to drive the pump assembly.

15. The chainsaw of claim 14, wherein selectively changing positions of the output shaft along the circumferential direction relative to the rotational axis of the motor shaft changes a position of the lubrication system along the circumferential direction.

16. The chainsaw of claim 14, the pump assembly comprising a pump body, the pump body comprising an inlet at which the reservoir is selectively attachable to provide a lubricant to the pump body, the pump body comprising an outlet through which the lubricant is provided to the guide bar through a conduit attached to the outlet.

17. A drive system for a chainsaw, the drive system comprising:
a motor shaft, wherein the motor shaft is configured to rotate relative to a first rotational axis extending through the motor shaft;
a motor operably coupled to drive the motor shaft;
a first housing, wherein the motor and the motor shaft are operably coupled to the first housing;
an output shaft, wherein the output shaft is configured to rotate relative to a second rotational axis extending through the output shaft, wherein the output shaft is separate from the motor shaft;
an output drive operably coupled to the output shaft; and
a transmission system, wherein the motor shaft and the output shaft are operably coupled to one another by the transmission system to transfer energy from the motor to the output drive, wherein the transmission system allows the second rotational axis at the output shaft to selectively change positions along a circumferential direction relative to the first rotational axis of the motor shaft.

18. The drive system of claim 17, the drive system comprising:
a first motor shaft bearing coupled to the motor shaft and the first housing; and
a second motor shaft bearing coupled to the motor shaft and a second housing.

19. The drive system of claim 18, the drive system comprising:
an output shaft bearing coupled to the output shaft and the second housing.

20. The drive system of claim 17, the transmission system comprising:
a first gear coupled to the motor shaft, the first gear co-rotational with the motor shaft relative to the first rotational axis;
a second gear coupled to the output shaft, the second gear co-rotational with the output shaft relative to the second rotational axis, wherein the first gear is operably coupled to transmit energy to the output shaft through the second gear.
